(19) United States
(12) Patent Application Publication
(10) Pub. No.: US 2016/0103963 A1
(43) Pub. Date: Apr. 14, 2016

(54) METHOD AND SYSTEM FOR SMART HEALTHCARE MANAGEMENT

(71) Applicant: VARUN MISHRA, BANGALORE (IN)

(72) Inventor: VARUN MISHRA, BANGALORE (IN)

(21) Appl. No.: 14/882,699

(22) Filed: Oct. 14, 2015

Related U.S. Application Data
(60) Provisional application No. 62/063,702, filed on Oct. 14, 2014.

(51) Int. Cl. G06F 19/00

(52) U.S. Cl. CPC G06F 19/323; G06F 19/3481; G06F 19/363

(57) ABSTRACT

Embodiments of the present invention disclose an improved method for smart healthcare management. The method comprises querying a card database via a card DBMS of a smart healthcare card comprising overall patient information of a patient using a smart healthcare card reader, adaptively and dynamically determining one or more contextual attributes of the overall patient information via identification, analysis and selection of one or more usable attributes based on the query, allowing selective access and retrieval of the one or more contextual attributes of the overall patient information by the smart healthcare card reader, analyzing the selectively accessed and retrieved contextual attributes using a host computing unit coupled to the smart healthcare card reader, recommending at least one of healthcare products, solutions, services and therapeutic regimens using the host computing unit coupled to the smart healthcare card reader and tracking efficacy of the at least one of recommended healthcare products, solutions, services and therapeutic regimens using the host computing unit coupled to the smart healthcare card reader.

### CROSS-REFERENCE TO RELATED APPLICATIONS

This application claims benefit of the U.S. Provisional Patent Application No. 62/063,702 filed Oct. 14, 2014, which is incorporated herein by reference in its entirety.

### BACKGROUND OF THE INVENTION

1. Field of the Invention

Embodiments of the present invention generally relate to smart healthcare management, and more particularly, to a method and system for smart healthcare management using smart health cards and portable computing and communication devices.

2. Description of the Related Art

Today technology has touched many aspects of healthcare, for example in terms of advances in drug research, medical equipment, etc. However, state-of-the-art health (or medical) and information technologies are still concentrated in niche markets, and thus not widely available for general public, especially in developing countries. Specifically, basic applications, such as health records, are still paper based in most of the developing and least developed countries.

Paper-based records require a significant amount of storage space compared to digital records. The costs of storage media, such as paper and film, per unit of information differ dramatically from that of electronic storage media. In the event that paper-based records are stored in different locations, collating them to a single location for review by a health care provider is time consuming and complicated. Specifically, person-centred records are impractical to maintain if not electronic, and thus difficult to centralize or federate. Likewise, in the event that paper-based records are required in multiple locations, copying, faxing, and transporting costs are significant compared to duplication and transfer of digital records. Further, paper-based records are prone to damage or loss. Still further, paper-based records may be incomprehensible and may have errors as they are hand-written. In addition, patients need to manage and carry all prior paper-based records prior to visiting hospitals, and are many times compelled to visit specific hospitals, where paper-based records of the patients are maintained in paper files.

Conventional community healthcare and healthcare networks, especially in developing nations, suffer from inherent drawbacks including, but not limited to, lack of technology integration, lack of proper health records, lack of overall mobility, lack of socio-economic independence of women and underprivileged, lack of maintenance of proper health records, lack of continuity in rural healthcare, operational and logistical difficulties, illiteracy and semi-literacy of stakeholders and beneficiaries and poor targeting in implementation of government schemes towards betterment of public health.

Therefore, there is still a need for the design and implementation of an improved method and system for smart healthcare management with enhanced qualitative and quantitative parameters, such as economical, easy usability, enhanced efficiency, transparency, mobility, scalability, diagnosability, personalizability, and integrability.

### SUMMARY OF THE INVENTION

Embodiments of the present invention disclose an improved method for smart healthcare management. The method comprises querying a card database via a card DBMS of a smart healthcare card comprising overall patient information of a patient using a smart healthcare card reader, adaptively and dynamically determining one or more contextual attributes of the overall patient information via identification, analysis and selection of one or more usable attributes based on the query, allowing selective access and retrieval of the one or more contextual attributes of the overall patient information by the smart healthcare card reader, analyzing the selectively accessed and retrieved contextual attributes using a host computing unit coupled to the smart healthcare card reader, recommending at least one of healthcare products, solutions, services and therapeutic regimens using the host computing unit coupled to the smart healthcare card reader and tracking efficacy of the at least one of recommended healthcare products, solutions, services and therapeutic regimens using the host computing unit coupled to the smart healthcare card reader.

These and other systems, processes, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

FIG. 1 depicts the improved system for smart healthcare management, according to one or more embodiments;

FIG. 2 depicts a block diagrammatic representation in connection with the architecture of the smart healthcare card, according to one or more embodiments;

FIG. 3 depicts a flow diagram of an improved method for smart healthcare management, according to one or more embodiments;

FIG. 4 illustrates a simplified example of the system 400 according to certain aspects of the invention;

FIG. 5 is a block schematic 500 depicting data flow in transactions involving transfer of EHR records according to certain aspects of the invention;

FIG. 6 illustrates a presentation of EHR information using a personalized portal according to certain aspects of the invention;

FIG. 7 is a flow chart of a method of health record exchange;

FIG. 8 is a conceptual block diagram 800 illustrating the functionality of an exemplary apparatus 802 as used in a provider location for accessing medical records;

FIG. 9 depicts the network subsystem comprising the HIE, according to one or more embodiments;

FIG. 10 depicts an integrated victim management unit deployed by the provider subsystem, according to one or more embodiments;

FIGS. 11-12 depicts performance and control the movement of healthcare records of consumers of healthcare virtually and globally, according to one or more embodiments;

FIG. 13 illustrates a flowchart showing an example of a preferred manner for creating a new account for the consumer 1212 in the management system 1210;

FIG. 14 illustrates a flowchart showing an example of a preferred manner for updating an existing account for the consumer 1212 in the management system 1210; and

FIG. 15 depicts a computer system that is at least one of a portable computing and communications device and a computer and can be utilized in various embodiments of the present invention, according to one or more embodiments.

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

While the improved method and system for smart healthcare management is described herein by way of example for several embodiments and illustrative drawings, those skilled in the art will recognize that the improved method and system for smart healthcare management, is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the improved method and system for smart healthcare management defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Various embodiments of an improved method and system for smart healthcare management are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

In some embodiments, an improved system for smart healthcare management is disclosed, according to one or more embodiments.

As used in medicine, the term “Evidence-Based Medicine (EBM)” refers to as the conscientious, explicit and judicious use of current best evidence in making decisions about the care of individual patients. Specifically, the EBM is defined as the use of mathematical estimates of the risk of benefit and harm, derived from high-quality research on population samples, to inform clinical decision-making in the diagnosis, investigation or management of individual patients. To broaden the application of the EBM from individual patients to health care services in general and to allied health professions, the EBM is also known as evidence-informed healthcare or evidence-based healthcare. The clinical approach is known as evidence-based practice.

In some embodiments, the improved system for smart healthcare management may facilitate implementation of ambulatory patient monitoring and EBM.

In some embodiments, the improved system for smart healthcare management may facilitate implementation of Wireless Medical Telemerty Service (WMTS).

In some embodiments, the patient subsystem may facilitate Shared Decision-Making (SDM). SDM is an approach where clinicians and patients communicate together using the best available evidence when faced with the task of making decisions, where patients are supported to deliberate about the possible attributes and consequences of options, to arrive at informed preferences in making a determination about the best action and which respects patient autonomy, where this is desired, ethical and legal.

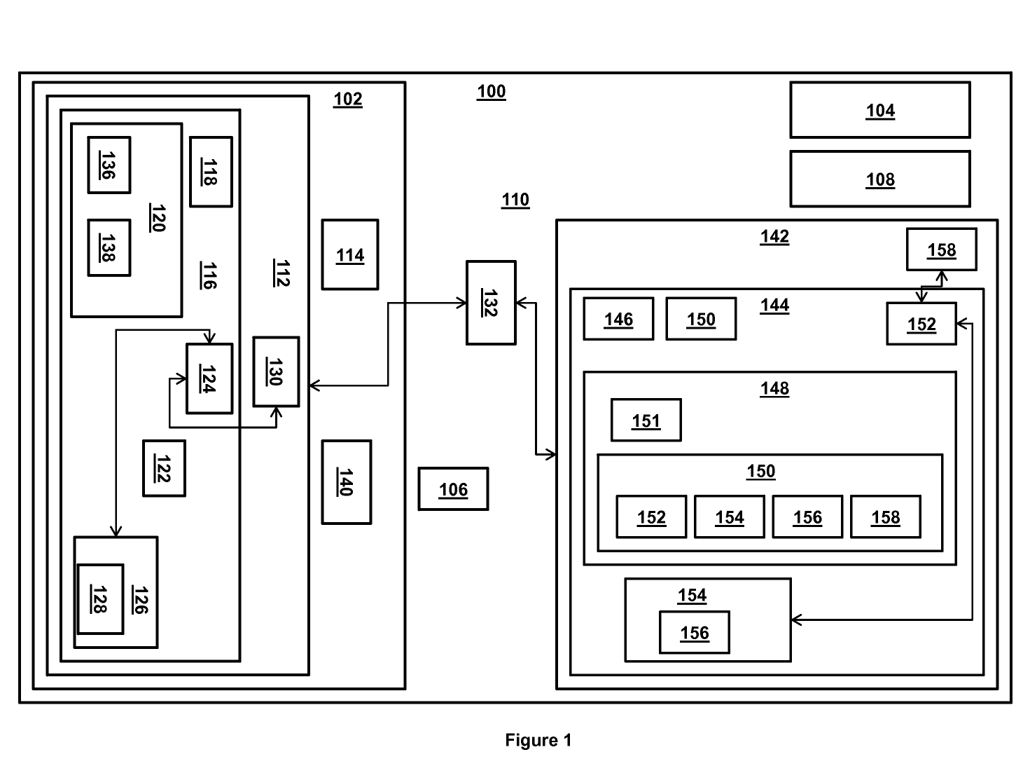

FIG. 1 depicts the improved system for smart healthcare management, according to one or more embodiments.

The system 100 may comprise one or more stakeholder subsystems, namely a patient subsystem 102, an employer subsystem 104, a provider subsystem 106, a payment subsystem 108, and one or more additional subsystems playing significant roles in facilitating rendering healthcare services, and one or more network subsystems 110.

In some embodiments, the patients may be capable of accessing, retrieving (or reading) and using their own information via deployment of 1) smart healthcare cards provided by the providers, 2) at least one of portable computing and communication devices with smart card readers coupled thereto and standalone portable smart card readers, all of which may be at least one of owned and operated by the patients.

In some embodiments, the patients may be capable of providing (or transmitting) their own information via deployment of 1) at least one of smart healthcare cards provided by the providers and portable computing and communication devices owned by the patients, and 2) at least one of portable computing and communication devices with smart card readers coupled thereto, and portable smart card readers, owned by the providers.

The patient subsystem 102 may comprise one or more patients, one or more portable computing and communications devices 112 owned by the patients and one or more smart healthcare cards 114 provided to the patients by the providers.

The portable computing and communications device 112 may comprise a first microcomputer unit 116. The first microcomputer unit 116 may comprise a first microprocessor subunit 118, first memory subunit 120, first set of support circuits 122 and a first I/O subunit 124. In addition, the first microcomputer unit 116 may comprise a first communication subunit 126. The first communication subunit 126 may comprise a first wireless transceiver 128. For example, and in no way limiting the scope of the invention, the first wireless transceiver 128 may comprise at least one of a General Packet Radio Service (GPRS) transceiver, Global System for Mobile Communications (GSM) transceiver, Near Field Communication (NFC) transceiver, BLUETOOTH® transceiver, and the like. In addition, the portable computing and communications device 112 may comprise a first display unit 130. In some scenarios, both the first communication subunit 126 and first display unit 130 may be coupled to the first I/O subunit 124.

For example, and in no way limiting the scope of the invention, the portable computing and communication devices 112 may be at least one of portable computers, tablet computers, Personal Digital Assistants (PDAs), ultra mobile Personal Computers (PCs), smartphones, carputers, pentop computers and the like.

In some embodiments, at least one of the fixed and portable computing and communications devices may facilitate reading information from, and writing onto, the smart healthcare cards, using at least one of smart healthcare card readers, smart healthcare card writers, and a combination thereof, for instance smart healthcare card readers/writers, coupled therewith (or thereto), thereby facilitating capturing information of patients, identifying (or detecting) the patients, tracking (or monitoring) the patients, for instance patient detection by tracking and patient tracking by detection, diagnosing (or analyzing) the patients, profiling the patients, categorizing the patients, treating the patients, recommending healthcare products, solutions, services or therauptic regimens and tracking efficacy of the recommendations made.

In some embodiments involving deployment of the smartphone 112 for reading or scanning information from the smart healthcare cards 114, the built-in camera of the smartphone 112 may be utilized to read the data or information stored on the smart healthcare cards 114 in the form of mobile tags based on the concept of mobile tagging. Specifically, the mobile tagging may provide the data or information read from the mobile tags, for instance commonly encoded in the Matrix (2D) barcodes, on the smart healthcare cards 114 for display on the smartphones 112, using the built-in cameras of the smartphones 112 as the reader devices. The contents of the mobile tags or Matrix (2D) barcodes are usually Uniform Resource Locators (URLs) for information addressed and accessible through Internet.

In some embodiments, the portable computing and communications device 112 may be a Near Field Communication (NFC)-enabled smartphone. Specifically, the NFC-enabled smartphone 112 may further comprise an NFC reader 132 (not shown here explicitly), wherein the smart healthcare card 114 may be an NFC-enabled smart card.

In some embodiments, the portable computing and communications device 112 may be a Radio Frequency Identification (RFID)-enabled smartphone. Specifically, the RFID-enabled smartphone 112 may further comprise an RFID reader 132 (not shown here explicitly), wherein the smart healthcare card 114 may be an RFID-enabled smart card.

In some embodiments involving deployment of a smart healthcare card reader 132 for reading or scanning information from the smart healthcare cards 114, the smart healthcare card reader 132 may be coupled to the smartphone 112. For example, and in no way limiting the scope of the invention, the smart healthcare card reader 132 may be at least one of integrally fixedly and externally removably (or detachably) coupled to the smartphone 112.

For example, and in no way limiting the scope of the invention, the smart healthcare card reader 132 may be at least one of contact (or proximity) and contactless (or vicinity) smart card reader. For example, and in no way limiting the scope of the invention, the contact smart healthcare card reader 132 may be at least one of a Document Insertion Processor (DIP) reader, an insertion type reader and a swipe card reader.

In some embodiments, the smart healthcare card reader 132 may be a contactless smart healthcare card reader. For example, and in no way limiting the scope of the invention, the contactless smart healthcare card reader 132 may be at least one of a contactless proximity and vicinity healthcare card reader.

In some embodiments, the smart healthcare cards may be capable of facilitating improving the security and privacy of patient information, providing secure carriers for portable medical records, reducing healthcare frauds, supporting new processes for portable medical records, providing secure access to emergency medical information, enabling compliance with government initiatives (e.g., organ donation) and mandates, and providing the platform to implement other applications as needed by the health care organizations. Specifically, the smart healthcare cards may be capable of facilitating identification, authentication, authorization, accounting, data storage and application processing. More specifically, the smart healthcare cards may be capable of facilitating providing strong security authentication for Single Sign-On (SSO) within large organizations.

For example, and in no way limiting the scope of the invention, the smart healthcare card 114 may be at least one of a smart card, chip card and Integrated Circuit Card (ICC), which may be any pocket-sized card with embedded integrated circuits. Specifically, the smart healthcare card 114 may be at least one of contact, contactless and hybrid smart card.

In some embodiments, the smart healthcare card may be capable of storing a wide variety of information facilitating use of the same in healthcare applications.

In some embodiments, the smart healthcare card may be a secure card capable of storing patient information in an offline mode. For example, the patient information may comprise at least one of current and prior medical history, such as identification and demographic information, for instance name, age, height, weight, medical encounters, for instance Chief Complaint (CC), History of the Present Illness (HPI), physical examination, assessment and plan, Past Medical History (PMH), for instance, surgical history, family history, habits, immunization history, growth chart and developmental history, sexual history, obstetric/gynecological history, past responses to Review of Systems (ROS), family diseases, chronic or childhood diseases, social history (medicine), regular and acute medications, allergies, orders and prescriptions, progress notes, test results, conclusions, closures, as well as general information like demographics, such as health insurance information, medical emergency information, and the like.

For example, and in no way limiting the scope of the invention, the smart healthcare card may be capable of storing one or more types of healthcare information including, but not limited to, patient demographics, for instance first, middle and last name, Date of Birth (DOB), primary care physician name, address, city, country, state/province, postal or zip code, unique medical record number, emergency contacts, telephone number, gender, advance directives, marital status, Social Security Number (SSN), unique driving license number, blood type, organ donor, language or mother tongue, faith or religion and unique corporate medical identification number; healthcare information updation date, for instance date last modified or updated; multiple allergy information, for instance allergy type, name of allergen, reaction, source (personal or discharge summary or clinical note) and severity; multiple medications information, for instance generic name and brand name; patient identity verification information, for instance Personal Identification Number(s) (PINs), patient photo or biometric information, identity management information; multiple medical problems information, for instance diagnosis or problem description, expression of problem; multiple surgeries and procedures information, for instance description, date, re-route pipeline to additional data; first responder, Federal Emergency Management Agency (FEMA)/Fracturing Responsibility and Awareness of Chemicals (FRAC) access information, for instance smart healthcare card reading authority, date stamp, audit trail and time limit; insurance or guarantor information, for instance multiple insurance dates, carrier, plan, policy, subscriber name, guarantor data, first, middle and last name, relationship to subscriber and address details; customized additional patient information, for instance implanted devices, pacemakers, artificial valves and defibrillators; customized payment information, for instance AMEX®/VISA®/MASTERCARD® credit/debit card, Health Savings Account/Health Spending Account (HSA) and social healthcare/insurance program.

In some embodiments, the smart healthcare card may be deployed for multiple applications including, but not limited to, financial, Subscriber Identity Modules (SIMs), identification, public transit, security, schools, organizations, healthcare, and multiple-use systems.

In some embodiments, the smart healthcare card comprising a distress Personal Identification Number (PIN) for use in at least one of unknown, unexpected, unwanted and untimely situations is disclosed, in accordance with the principles of the present invention. Specifically, the smart healthcare card may comprise a regular PIN and the distress PIN. In some scenarios, in use, users may be able to use the distress PIN in at least one of unknown, unexpected, unwanted and untimely situations. However, in some normal scenarios, the users may be able to use the at least one of regular and distress PIN, thereby facilitating Authentication, Authorization and Accounting (AAA).

In some scenarios involving use of the smart healthcare card comprising the distress Personal Identification Number (PIN), the users may be capable of using the smart healthcare card at any health ATM installed at the premises of any healthcare service provider. In some at least one of unknown, unexpected, unwanted and untimely situations, the users may be capable of availing the emergency healthcare facilities provided by one or more healthcare service providers via at least one of swiping the smart healthcare card through, feeding into and exposing the same before, or in proximity of, the at least one of contact and contactless smart healthcare card reader, respectively.

In some embodiments, user controlled access to the information stored in the smart healthcare card, thereby facilitating user to selectively approve retrieval and use of any and all information stored therein by second and third parties is disclosed, in accordance with the principles of the present invention.

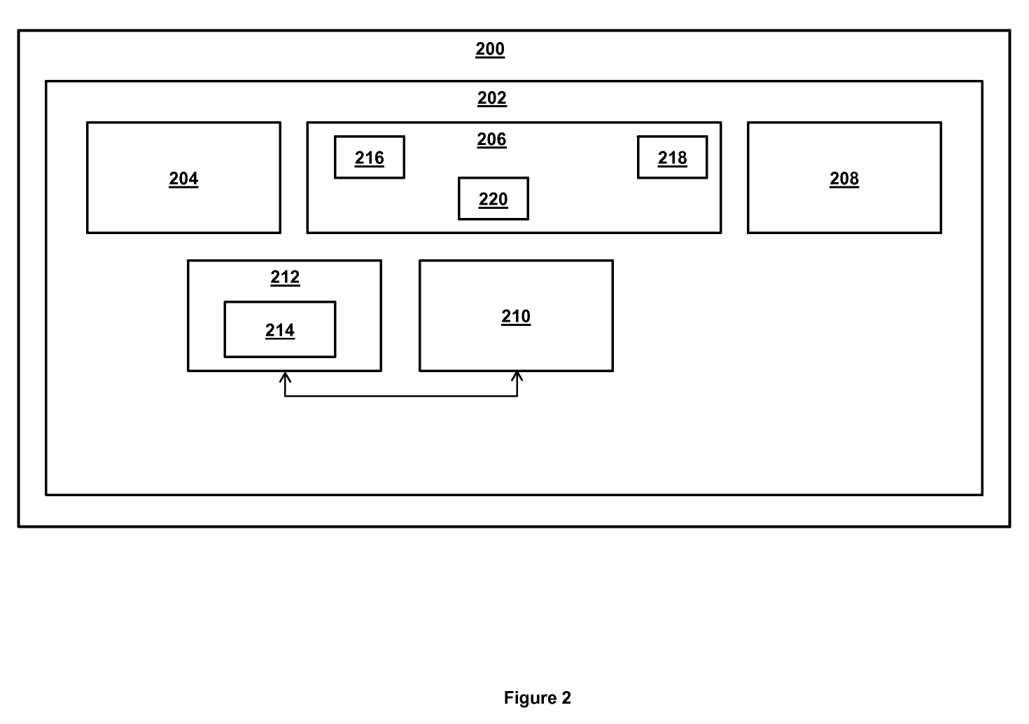

FIG. 2 depicts a block diagrammatic representation in connection with the architecture of the smart healthcare card, according to one or more embodiments.

The smart healthcare card 200 may comprise a card microcomputer unit 202. The card microcomputer unit 202 may comprise a card microprocessor subunit 204, card memory subunit 206, set of card support circuits 208 and a card I/O subunit 210. In addition, the card microcomputer unit 202 may comprise a card communication subunit 212 coupled to the card I/O subunit 210. The card communication subunit 212 may comprise a card wireless transceiver 214.

In some embodiments, the card memory subunit may be capable of facilitating storage and management of patient information. The card memory subunit may be capable of facilitating storage and implementation of a card-side proprietary healthcare application software and Database Management System (DBMS) thereby facilitating overall management of patient information. For purposes of clarity and expediency, the proprietary application software may be hereinafter interchangeably referred to as at least one of the card-side proprietary healthcare application software and patient information management module.

As depicted in FIG. 2, the card memory subunit 206 may comprise a card Operating System (OS) 216, a card-side proprietary healthcare application software 218 and a card DBMS 220. For example, and in no way limiting the scope of the invention, the card OS 218 may be a Reduced Instruction Set Computing (RISC) OS, for instance RISC/OS™. For example, and in no way limiting the scope the invention, the card DBMS 220 may be an at least one of a micro and pico DBMS 220.

In some embodiments, the card DBMS may be capable of facilitating storage and management of the patient information in the form of one or more records. Specifically, each individual record may be stored in a database, wherein each individual record may comprise one or more attributes or fields. More specifically, the one or more attributes may comprise patient information and corresponding metadata therefor. The card DBMS may be capable of facilitating at least one of sequential, random and customized searching (or scanning) of one or more records comprising multimedia information and corresponding metadata therefor, based on one or more criterion, for instance explicit user-definable criteria.

Referring to FIGS. 1-2, in use, the smart healthcare card reader 132 may attempt to access the information stored in the smart healthcare card 200. Specifically, the smart healthcare card reader 232 may send one or more queries to the card DBMS 220 of the smart healthcare card 200. Based on the contents of the queries, the card DBMS 220 may adaptively and dynamically identify, analyze, select and determine one or more attributes or fields of a given patient record so as to allow access to the smart healthcare card reader 132. Thus, the smart healthcare card 200 may facilitate user controlled access to the determined one or more attributes or fields of a given patient record to the second and third parties via selectively allowing access, retrieval and use thereof.

Referring to FIGS. 1-2, the first memory subunit 120 of the portable computing and communications device 112 comprises a first Operating System (OS) 136 and a card-side proprietary healthcare application software 138, for example an instance of the proprietary healthcare application software 218.

In use, the proprietary healthcare application software 138 may present one or more subjective and objective questionnaire in connection with the overall health of patients, such as health, lifestyle, diet, medical history and the like, on the first display unit 130 of the portable computing and communications device 112.

In use, the patient may respond to the subjective and objective questionnaire. Upon response, the proprietary healthcare application software 138 may facilitate capturing the responses to the subjective and objective questionnaire.

Further, in use, one or more physiological sensors or biosensors 140 coupled to the portable computing and communications device 112 may facilitate capturing one or more physiological or biological parameters, such as Electrocardiography (ECG) sensor, SpO2 (Oxygen saturation) sensor, Electroencephalography (EEG) sensor, Blood Glucose sensor, body temperature sensor, body pressure sensor, Electromyography (EMG) sensor, Mechanomyogram (MMG) sensor, Electrooculography (EOG/E.O.G.) sensor, Electrodermal Activity (EDA) sensor, Magnetoencephalography (MEG) sensor, and the like.

As depicted in FIG. 1, in some embodiments, the smart healthcare card reader 132 may be coupled to a host computing device 142. The host computing device 142 may comprise a second microcomputer unit 144. The second microcomputer unit 144 may comprise a second microprocessor subunit 146, second memory subunit 148, second set of support circuits 150 and a second I/O subunit 152. In addition, the second microcomputer unit 144 may comprise a second communication subunit 154. The second communication subunit 154 may comprise a second wireless transceiver 156. For example, and in no way limiting the scope of the invention, the second wireless transceiver 156 may comprise at least one of a General Packet Radio Service (GPRS) transceiver, Global System for Mobile Communications (GSM) transceiver, Near Field Communication (NFC) transceiver, BLUETOOTH® transceiver, and the like. In addition, the host computing device 142 may comprise a second display subunit 158. In some scenarios, both the second communication subunit 154 and second display subunit 158 may be coupled to the second I/O subunit 152.

Referring to FIGS. 1-2, in use, the smart healthcare card reader 132 may query the card database via the card DBMS 220 of the smart healthcare card 114 or 200 comprising overall patient information of a patient. The card DBMS 220 may adaptively and dynamically determine one or more contextual attributes of the overall patient information via identification, analysis and selection of one or more attributes based on or relevant to the query. Upon determination, the card DBMS 220 may allow selective access and retrieval of the contents corresponding to the one or more contextual attributes of the overall patient information by the smart healthcare card reader 132.

As depicted in FIG. 1, the second memory subunit 148 of the host computing device 142 coupled to the smart healthcare card reader 132 may comprise a card-reader side patient information management application 150 and a second OS 151.

The card-reader side patient information management application 150 may comprise a patient information analyzer 152, information collator 154, recommendation engine 156 and efficacy tracker 158.

In operation, the patient information analyzer 152 may analyze the selectively accessed and retrieved contextual attributes.

The information collator 154 may collate A) the selectively accessed and retrieved contextual attributes, B) the physiological attributes of the patient captured using the one or more physiological sensors or biosensors 140 coupled to the portable computing and communications device 112 and C) the responses of the patient to one or more subjective and objective questionnaire captured using the card-side patient information management module 218.

The recommendation engine 156 may recommend at least one of healthcare products, solutions, services and therapeutic regimens using the host computing device 142 coupled to the smart healthcare card reader 132.

The efficacy tracker 158 may track the efficacy of the at least one of recommended healthcare products, solutions, services and therapeutic regimens using the host computing device 142 coupled to the smart healthcare card reader 132.

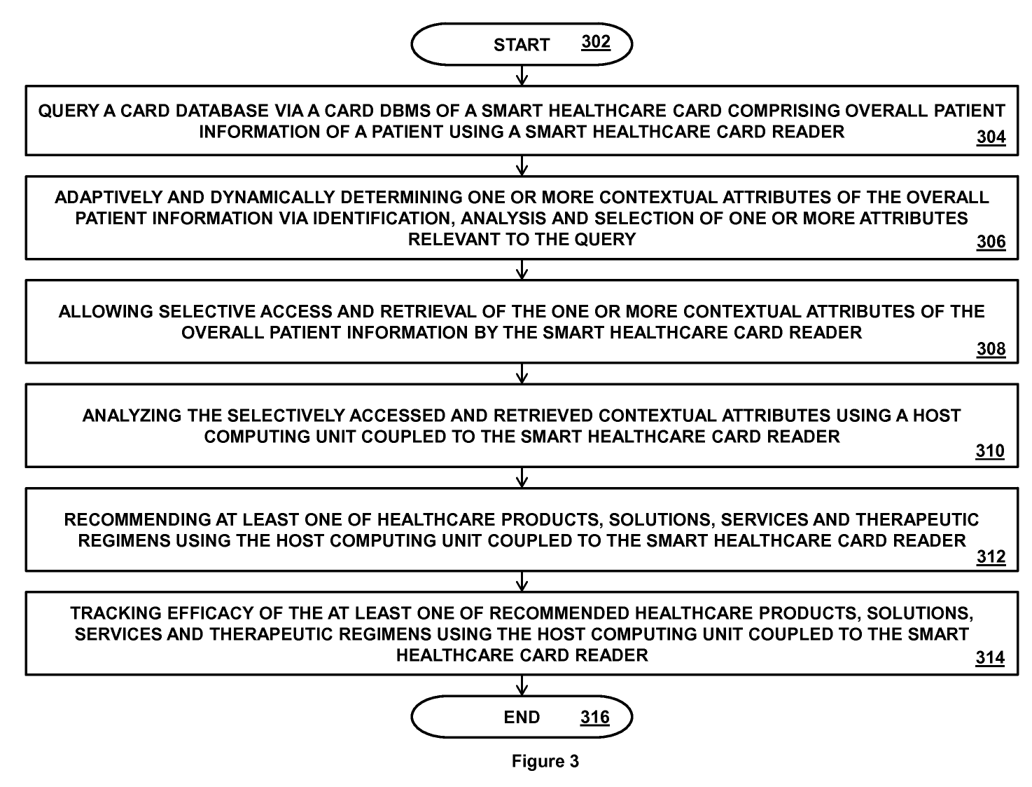

FIG. 3 depicts a flow diagram of an improved method for smart healthcare management, according to one or more embodiments.

The method 300 starts at step 302 and proceeds to step 304.

At step 304, the method 300 may comprise, or facilitate, querying a card database via a card DBMS of a smart healthcare card comprising overall patient information of a patient using a smart healthcare card reader.

At step 306, the method 300 may comprise, or facilitate, adaptively and dynamically determining one or more contextual attributes of the overall patient information via identification, analysis and selection of one or more attributes relevant to the query.

At step 308, the method 300 may comprise, or facilitate, allowing selective access and retrieval of the one or more contextual attributes of the overall patient information by the smart healthcare card reader.

At step 310, the method 300 may comprise, or facilitate, analyzing the selectively accessed and retrieved contextual attributes using a host computing unit coupled to the smart healthcare card reader.

At step 310, the method 300 may further comprise, or facilitate, capturing one or more physiological attributes of the patient using one or more physiological sensors using a portable computing and communications device, capturing responses of the patient to one or more subjective and objective questionnaire using the portable computing and communications device, and consolidating the captured physiological attributes, responses to the subjective and objective questionnaire and the selectively accessed and retrieved contextual attributes of the patient using the host computing unit coupled to the smart healthcare card reader.

At step 312, the method 300 may comprise, or facilitate, recommending at least one of healthcare products, solutions, services and therapeutic regimens using the host computing unit coupled to the smart healthcare card reader.

At step 314, the method 300 comprise, or facilitate, tracking efficacy of the at least one of recommended healthcare products, solutions, services and therapeutic regimens using the host computing unit coupled to the smart healthcare card reader.

The method 300 proceeds to step 316 and ends.

Referring to FIGS. 1-2, in some embodiments, the first wireless transceiver 128 of the portable computing and communications device 112 may be coupled to one or more sensors, for instance ambient sensors (not explicitly shown and numbered herein). For example, and in no way limiting the scope of the invention, the one or more sensors may be at least one of acoustic, sound, or vibration sensors, for instance a microphone; chemical sensors, for instance a Carbon Dioxide (CO₂) sensor, Carbon Monoxide (CO) detector, electrochemical gas sensor, electronic nose, hydrogen sensor, olfactometer, oxygen sensor (or lambda sensor), smoke detector, and a combination thereof; electric current, electric potential, magnetic, or radio sensors, for instance a current sensor, voltage detector and a combination thereof; environment, weather, moisture, or humidity sensors, for instance a wireless bedwetting alarm, gas detector, humistor, hygrometer, and a combination thereof; position, angle, displacement, distance, speed, or acceleration sensors, for instance, a photoelectric sensor, position sensor, and a combination thereof; proximity, or presence sensors, for instance an alarm sensor, motion detector, an occupancy sensor, a proximity sensor, Passive Infrared Sensor (PIR) sensor, triangulation sensors, touch switch, and a combination thereof, and the rest.

In some embodiments, in use, at least one of an individual sensor and a combination thereof may capture corresponding one or more physical quantities in the form of analog signals. In some embodiments, an Analog-to-Digital Converter (ADC) may convert the analog signals into corresponding digital signals, i.e. digital representation of the analog signals. The digital signal(s) may be readable by any suitable electronic device.

In some embodiments, in operation, the one or more digital signals from the one or more sensors may be received by the first wireless transceiver 128. The first microprocessor subunit 118 may facilitate processing of the digital signals. The first memory subunit 120 may be capable of storing the digital representation of the analog signals in the form of context information.

Further, in use, the first wireless transceiver 128, for instance the BLUETOOTH® transceiver, may facilitate transmission of the context information to the card-side proprietary healthcare application software 218.

In operation, the card-side proprietary healthcare application software 218 may access the overall profile information of the patient using the card DBMS 220. The card-side proprietary healthcare application software 218 may facilitate consolidation of the context information received from the portable computing and communications device 112 with the overall profile information of the patient, thereby facilitating recomminding do's and don'ts to the patient based on the current context, in light of the current health condition of the patient.

In some embodiments, the provider subsystem may comprise one or more healthcare service providers and one or more healthcare insurance service providers.

For example, and in no way limiting the scope of the invention, the healthcare service providers may be at least one of an institution, such as a hospital, nursing home, clinic and medical school, and individuals, such as practitioners and professionals, for instance mental health practitioners, maternal and newborn health practitioners, geriatric care practitioners, surgical practitioners, rehabilitation care practitioners, eye care practitioners, oral health practitioners, foot care practitioners, public health practitioners, traditional and complementary medicine practitioners and the like. The healthcare service providers may be capable of providing or rendering healthcare services, such as diagnosis and treatment.

In some scenarios, the health professionals may provide at least one of preventive, curative, promotional and rehabilitative health care services in a systematic way to individuals, families or communities. Specifically, the health professionals may be within at least one of medicine, midwifery (obstetrics), dentistry, nursing, pharmacy and allied health professions. In addition, the health professionals may also be public or community health professionals.

In some embodiments, the provider subsystem may comprise one or more Payment Service Providers (PSPs). The PSPs offer (web) shops online services for accepting electronic payments by a variety of payment methods including credit card, bank-based payments, such as direct debit, bank transfer, and real-time bank transfer based on online banking. Typically, the PSPs use a Software-as-a-Service (SAAS) model and form a single payment gateway for the clients (merchants) to multiple payment methods.

Various aspects of the present disclosure relate to an example involving Electronic Health Records (EHRs), although the various aspects of the invention may relate to the management and access of other types of records, including legal records, financial records, employment records, and so on. For example, certain aspects of the invention are applicable to Point-of-Sale (POS) authorization and identification of the parties to a transaction. In another example, certain aspects of the invention may enable secure transactions and exchange of information between clients and financial institutions.

In some embodiments, the provider subsystem may facilitate management of Electronic Health Records (EHRs).

In some embodiments, the Electronic Health Records (EHRs), or Electronic Medical Records (EMRs), may be a systematic collection of electronic health information about patient or population. Specifically, the EHRs are records in digital format that may be theoretically capable of being shared across different health care settings. In some scenarios, the sharing may occur by way of network-connected, enterprise-wide information systems and other information networks or exchanges. EHRs may include a range of data, including demographics, medical history, medication and allergies, immunization status, laboratory test results, radiology images, vital signs, personal statistics like age and weight, and billing information.

In some embodiments, EHR may be designed to represent data that accurately captures the state of the patient at all times. EHR may be capable of allowing for an entire patient history to be viewed without the need to track down the patient's previous medical record volume and may assist in ensuring data accuracy, appropriateness and legible. EHR may be capable of reducing the chances of data replication owing to only one modifiable file, which means the file may be constantly up to date when viewed at a later date and may eliminate the issue of lost forms or paperwork. Due to all the information being in a single file, EHR may be capable of making the information much more effective when extracting medical data for the examination of possible trends and long term changes in the patient.

EHR may facilitate digital formatting thereby enabling use and sharing of information over secure networks. EHR may facilitate tracking care, for instance prescriptions, and outcomes, for instance test results comprising blood pressure and other vital physiological parameters. EHR may facilitate triggering warnings and reminders. EHR may facilitate sending and receiving orders, reports and results.

In some embodiments involving deployment of Health Information Exchange (HIE), HIE provides for a technical and social framework that enables information, for instance EHRs, to move electronically between organizations. HIE facilitates reporting to public health entitites. HIE facilitates ePrescribing and sharing laboratory results with providers.

In some scenarios, deployment of EHR may facilitate reading and writing a patient's record not only through a workstation but, depending on the type of system and health care settings, deployment of EHR may also may facilitate reading and writing the patient's record through mobile devices that are handwriting capable, for instance tablets and smartphones. EHRs may include access to Personal Health Records (PHR), which makes individual notes from an EMR readily visible and accessible for consumers.

In some embodiments involving deployment and implementation of smart healthcare management systems based on EHR, automatic monitoring of clinical events, by analyzing patient data from EHR to predict, detect and potentially prevent adverse events is disclosed, in accordance with the principles of the present invention. For example, clinical events may include discharge/transfer orders, pharmacy orders, radiology results, laboratory results and any other data from ancillary services or provider notes.

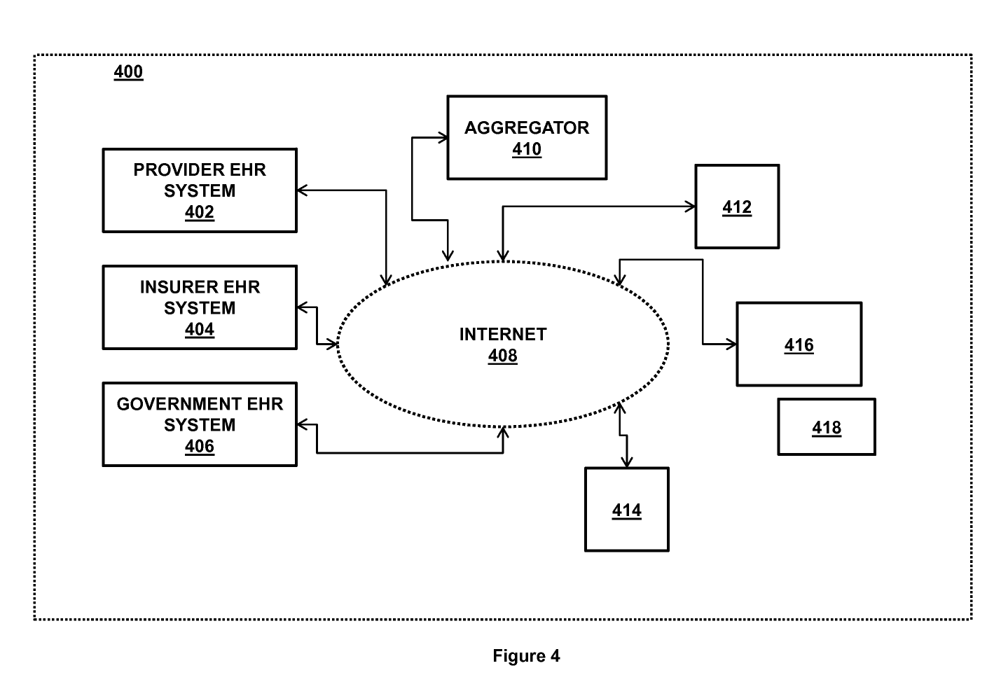

FIG. 4 illustrates a simplified example of the system 400 according to certain aspects of the invention. Electronic Health Records (EHRs) may be maintained in various locations and/or stakeholder entities. For example, and in no way limiting the scope of the invention, the EHRs may be maintained by one or more healthcare service providers 402, or payers, such as insurers 404, and government entities 406. The EHRs maintained by the stakeholder entities 402, 404, and 406 may include duplicate information maintained in two or more of the stakeholder entities 402, 404, and 406, although based on a reasonable prediction at least some EHR information may be maintained in a single one of the stakeholder entities 402, 404, and 406.

In operation, a user may access records through a mobile device 412 or 414, such as a smart phone, a tablet computing device, a notebook computer, or other suitable mobile device. For instance, the user may be a service provider or an individual record owner who may be a patient of a provider and/or an individual insured by an insurer, or an agent of the record owner. Typically, the record owner is a patient who may receive healthcare services in multiple locations and/or from multiple healthcare providers. Healthcare providers may include one or more of a primary care provider (physician), a physician specialist, and a pharmacy. The patient may be insured by a private or public health insurance plan. Each of these different healthcare providers may maintain separate and distinct electronic health records for the patient.

For example, and in no way limiting the scope of the invention, the healthcare providers may include one or more healthcare practitioners and professionals including, but not limited to, mental health practitioners, maternal and newborn health practitioners, geriatric care practitioners, surgical practitioners, rehabilitation care practitioners, eye care practitioners, oral health practitioners, foot care practitioners, public health practitioners, traditional and complementary medicine practitioners, and the like.

The mobile device 412 or 414 may be adapted or configured, using an installed or downloaded application or agent to enable access to personal electronic health records that may be maintained on one or more centralized databases 402, 404 and 406. The user may typically access electronic health records related to a transaction or the provision of healthcare services to a patient, and the records accessed may comprise personal health records, such as medical records and insurance records, which may be remotely located on the centralized databases embodied in host computing units owned, managed and operated by the stakeholder entities 402, 404, and 406.

In some embodiments, the EHR databases maintained by the stakeholder entities 402, 404, and 206 may be accessed through a network 408. The network 408 may comprise one or more of a wireless network, a cellular access network, the Internet and/or a private network, etc. In some embodiments, a record owner can access EHR databases individually to retrieve records related to a specific activity, service, and/or provider. In some embodiments, the record owner may identify a set of EHR databases to be accessed and combined, collated, or merged to obtain one or more of a combined record or combined report of EHRs. In some embodiments, the record user can specify a type of record to be accessed, regardless of which EHR databases maintain such records. In some embodiments, a record owner can generate a combined individual record for immediate access and use by the user, or for delivery to a healthcare provider such as a physician, typically on the healthcare provider-side host computing unit. The record owner may produce a combined record on-demand (on-the-fly), or may provide access to a combined individual record that is maintained by, or on behalf of the record owner and which is typically updated automatically and/or periodically. In some embodiments, the record owner may authorize and/or enable a provider to access records from a single EHR source, from multiple sources, and/or from an aggregator 410. In some embodiments, a record owner may authorize and/or enable a provider to access certain types of records, regardless of the location of those records.

As illustrated in FIG. 4, the individual records may be delivered to a physician's mobile computing device 412, such as a tablet computer or smart phone, although the combined individual record may also be delivered to a server or other computer of the stakeholder entities 402, 404 and 406. In some embodiments, the record owner may cause a server or other network device 410 to deliver the combined individual record to the stakeholder entities 402, 404, or 406 and/or to a physician's mobile computing device 412 or other computing device, such as a desktop computer. Aggregator 410 may be used to provide individual records when a record owner does not have access to a device 414 capable of producing and delivering the individual record or when the record owner's device 414 cannot connect to provider's computing device 412 or the stakeholder entities 402, 404, or 406.

Identification and authentication information may be maintained on record holder's device 414 to permit record owner to access each of the stakeholder entities 402, 404, and 406. The maintenance and control of the identification and authentication information by the records owner may reduce overall system complexity because a single command and identification process at device 414 may cause automatic access of relevant records on EHR systems 402, 404, 406 and/or from aggregator 410. For example, an agent installed on the record owner mobile device 414 may be configured to identify and authenticate the user of the device 414 through password, challenge, biometric scan and/or other means for authentication known in the art. Authentication may optionally be confirmed by a trusted third party device or service provider. Authentication information may be provided to each of stakeholder entities 402, 404, and 406 and/or aggregator 410 to enable access to the EHR information related to the record owner.

The process of authentication and/or point of origin of the request may be recorded and may be used to prove consent of a record holder to a transfer of records to a provider. In some embodiments, a request from a user to transfer records may be considered to include consent of the record owner, based on prior identification and/or authentication of the identity of the user as the record holder. The record owner may be presented with a request to confirm transfer request. The request for confirmation may include a request for identification and/or a request to authenticate the identity of the recipient of the transfer request. In some embodiments, the user may configure the type of transfer to be performed for each request. For example, consent may be limited to a subset of the owner's EHR record. In some embodiments, the record owner may configure a default specification of the types of record that can be transferred to one or more service providers.

The user may authorize and/or initiate an access to electronic health records at a service provider facility. The user may prepare a combined EHR report or may store a set of EHR information from a variety of sources on a mobile device or on a storage device. Locally maintained information is typically encrypted. The record holder may transfer a portion or all of locally maintained information to a healthcare provider when seeking healthcare services. The user may also access certain records on-line from home to check on his insurance status, medical appointments, to see prescription refill status or to communicate by e-mail with his physicians.

Certain embodiments provide an interface to multiple electronic health records for both users and service providers. A user may provide authorization that enables a service provider to access some or all of the user's combined records. Thus, a provider may, at the user's discretion, access the user's individual EHRs maintained by a different provider at a different healthcare facility. In one example, a physician may directly, and easily, access all of the user records necessary to obtain a current view of the user's complete medical history, insurance eligibility status, and other information. Moreover, medical practitioners can directly access the user's records in order to update the user's health information.

When transferring records, the user identification may be authenticated using any combination of a user ID, password, challenge question and biometric information. Typically, the transfer is made contingent upon a two-way identification of a record holder and a healthcare provider. In-person identification may be made using direct sight. Additionally, both users' portable devices may establish a connection that is confirmed by both the record holder and the healthcare provider. In one example, the connection may comprise a session secured using encryption keys that are exchanged between the users. The encryption keys may be used to encrypt and decrypt information transmitted between the devices of the users. The transfer may be made only between proximately located devices. In one example, the record holder may initiate contact by selecting a physician's tablet computer from a list of devices within Bluetooth range, or within the same WiFi domain. The physician typically accepts the connection.

In certain embodiments, records may not be exchanged without a positive identification of the recipient. When the record holder and the healthcare provider are located in different physical locations, a location identification made by one or more of the record holder and the healthcare provider using one or more of a global positioning system and location information provided by a wireless network. For example, certain wireless network telecommunications services can provide accurate positional information based on triangulation and/or certain signaling characteristics of mobile devices. In some embodiments, an authentication or other service may be used to verify identity of, and subsequently connect a record holder and a healthcare provider when the parties are located different physical locations.

In certain embodiments, the user devices may be incompatible and may not be capable of direct connection. For example, and Android-based device may not be able to connect securely with a tablet computer based on a different operating system. When incompatible devices are used, a gateway may be used to facilitate the connection of the devices and may provide extended handshake services that identify both devices and establish a secure link between the devices. The gateway may be provided using a local or network server and/or a cloud service.

In certain embodiments, global positioning technology may be used to confirm proximity or specific locations of the record holder and provider devices. In some embodiments, cell technology, such as 4G LTE may provide location services to determine proximity or physical location information.

General purpose computing devices 416, such as a notebook or desktop computer, may also be used to access medical records, even where the computer 416 does not belong to the record owner. Record owner may provide an electronic credential 418 that, when read and used by computer 416, enables automatic access of combined individual records. Electronic credential 418 may comprise a hand-held device with a non-transitory memory and an embedded microprocessor or other programmable device. The electronic credentials may comprise a smart card, a USB flash drive, and radio-frequency identification (RFID) device, an NFC token, web-enabled phones, etc, and the credential may be embodied in an identification card or other format easily stored and secured by the user. In certain embodiments, access to the user's EHR information may be obtained by presenting the electronic credential 418 to a computing device 412 or 416, whereby the computing device can establish a wired or wireless connection with the electronic credential 418 that enables an exchange of data. The electronic credential 418 may comprise a small portable device issued by an insurer, a government agency, a primary healthcare provider system, etc. The electronic credential 418 may comprise a memory that maintains information including a personal identifier, a unique identifier assigned to the individual, an EHR locator address, login information, and/or other identifying information. The user may use the electronic credential 418 to access one or more EHR systems 402, 404, and 406 through a computing device 412 or 416, such as a personal computer (PC), tablet computer, smart phone or other suitably equipped processing device. In one example, the electronic credential 418 comprises a flash drive, a smart card, or a device that can connect wirelessly to the computing device 412 or 416. The user may present the electronic credential 418 to the computing device 412 or 416 in a manner appropriate to allow the electronic credential 418 to exchange information with the computing device 412 or 416, whereby the computing device 412 or 416 may automatically access and login to one or more EHR systems 402, 404, and 406 using the record owner's identification. The user may have access to the EHR systems 402, 404, and 406 for automated and simultaneous real-time access to medical records maintained therein. In one example, an agent or other application software embedded in the electronic credential 418, or accessed through a network 408 using information stored on the electronic credential 418, may be downloaded to the computing device 412 or 416 to enable harvesting of selected data from the different EHR systems 402, 404, and 406 and generate an on-the-fly summary record for a physician to view and use.

Certain embodiments enable automated access to multiple data sources. In one example, electronic credential 418 comprises an encrypted “electronic keychain” that may be maintained as a knowledge base that comprises identification and lists of sources of health related information for an individual. The knowledge base can include both the Internet address as well as identification and other credentials needed to enable access to the data. Typically the health information is maintained by a plurality of healthcare providers or practitioners, and information may be accessible through repositories or databases, including insurance databases and healthcare record portals.

An electronic credential 418 may comprise a device that includes a combination of hardware and software that can encrypt and decrypt information stored on the electronic credential 418. The electronic credential 418 may be embodied in intelligent electronic devices (devices having at least a programmable controller), such as a universal serial device, a smart phone, a PC and a tablet computer. The electronic device may have sufficient processing capacity and storage to operate as a self-contained EHR access portal.

In certain embodiments, an on-the-fly summary of health information can be provided at a medical provider facility, for example. Information provided by an electronic keychain may be used to initiate access and retrieval of information from multiple EHR sources 402, 404, and 406. Information provided by the electronic keychain may include one or more agents or applications that may compile multiple electronic health records into a single summary form. The summary form may be provided in a standardized format, such as Continuity of Care Record (“CCR”), a Continuity of Care Document (“CCD”), and other suitable formats. In some embodiments, compiled health records may be presented in a consistent summary format regardless of the format used by the originating source. Accordingly, information provided or accessed through the electronic keychain may include templates and conversion modules that can be used to filter and reformat EHR information from a variety of sources 402, 404, and 406.

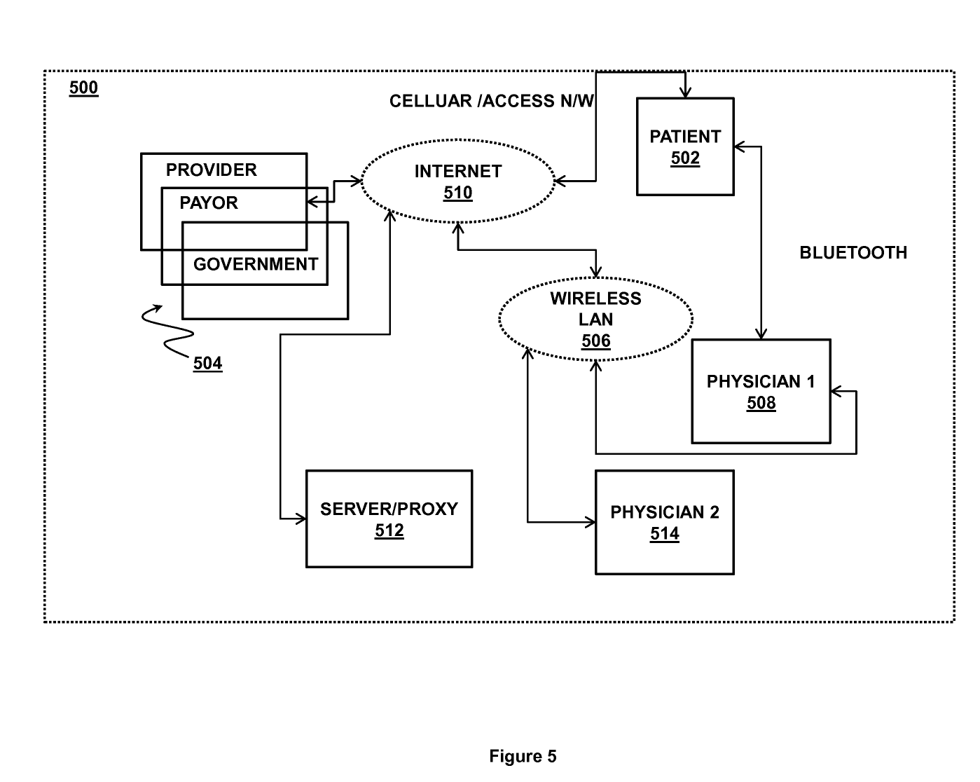

FIG. 5 is a block schematic 500 depicting data flow in transactions involving transfer of EHR records according to certain aspects of the invention. In a first scenario, a record owner may use a personal portable computing device 502 to directly transfer, or push, a combined record to a first provider device 508. For example, a patient visiting a physician's office may wish to provide updated records to the attending physician. The patient may initiate an agent or other application on a smart phone 502 to perform the transfer. The user may be required to provide identifying information, such as a username, a password, an answer to a challenge question and/or the user may be required to provide biometric information. The user may typically select which records should be provided to the physician.

Upon authentication, the agent may determine if a single or combined record is maintained on the patient device 502 and whether such record is current. The agent may request records from one or more healthcare providers, insurers, government agency, public payer or other source of EHR information (shown generally at 504). Having combined or updated the individual record or records, the agent may cause the patient device 502 to push a single record or combined records to the physician device 508 for immediate display. An application or agent on the physician device 508 may be manually initiated to receive the pushed information. In some embodiments, the physician device 508 may be adapted to respond to the push by opening an application or agent to receive or display the records upon receipt of a request for connection from patient device 502.

In certain embodiments, the physician may update records or retrieve other records on the physician device 508 and cause the updated or other records to be transmitted to the patient device 502. The patient device 502 may then provide the new or updated records to one or more of the EHR systems 504 or to another provider's computing device. In some embodiments, the physician may provide medical information to the patient device 502. For example, the physician may receive an X-Ray image on device 508 and may transfer the image to the patient device 502. In another example, the physician may cause device 508 to transmit information to the patient device that provides access to instructional or educational information to the patient device 502, including information on medications, dosage regimens and general information, such as educational information related to a medical condition.

User device 502 and physician device 508 may communicate using any available network or communication method, including WiFi, cellular communications, Bluetooth and other short range wireless communications. In certain embodiments, communication between devices 502 and 508 may be restricted to the use of short range communications methods to enhance security. For example, the use of a Bluetooth link between physician device 508 and patient device 502 may limit communications range to a single room, allowing both the physician and patient to verify that communication is properly established between devices 502 and 508 and the patient's privacy can be better protected. In certain embodiments, a patient may wish to transfer records to a physician who is not physically present using a wireless LAN 506 located in a medical facility and/or through the Internet 510 where the physician and patient are geographically remote from one another. In such cases, the patient and physician may establish a video conference connection to verify that verify that communication is properly established between devices 502 and 508.

In a second scenario depicted in FIG. 5, a server 512 may act as an intermediary or proxy between patient device 502 and a second physician device 514. As described for the first scenario, the patient may initiate a records transfer using device 512. In certain embodiments, intermediary 512 may provide one or more services, including user identification and authentication and record aggregation when patient device 502 is not configured or adaptable to perform such functions. For example, record owner may provide an electronic credential 518 to a general purpose computing device 516, whereby the electronic credential 518 causes the computer 516 to transmit a request for service to the proxy 512. Proxy 512 may, for example, provide a web page to computer 516 which allows the patient to initiate a request that may be executed by proxy 512 on behalf of the patient.

In another example, patient device 502 and second physician 514 may be unable to directly communicate. Intermediary 512 may be configured to perform a gateway or routing function that permits exchange of information between 502 and 514 to communicate. Devices 502 and 514 may be unable to establish Bluetooth or WiFi connections with one another due to security settings of second physician device 514 and/or wireless LAN 506. In one example, intermediary 512 through a WiFi network may provide a gateway function when patient device 502 is connected to a different domain (guest domain), while the second physician device 514 is connected via a secured private domain of a local network 506.

In certain embodiments, proximity may be defined as closeness in both place and time. A proximity exchange may occur when real-time communication of health records and/or health information occurs between patient and physician devices 502 and 508 while the devices 502 and 508 are in physical proximity with each other and the users can identify each other by direct sight. In certain embodiments, proximity exchange may be used to communicate health records and/or health information from a first mobile device 502 to a second mobile device 508 over a local wireless network during a specific time period. The time period may be defined by a starting time when the communicating parties can identify each other by direct sight, either by physically seeing each other or by virtually viewing via video communication. Typically, the two people exchanging information will be together in the same room during the proximity exchange. As an example, a patient with a mobile phone 502 can send his health records to his doctor who is waiting with his tablet 308 in the same examining room. In another example, the doctor at the end of the visit can send to the patient some treatment instructions or literature related to his patient's diagnosis. In addition to having proximity of space (i.e. being in the same room) the patient and the doctor also have proximity of time. Each is expecting the communication to occur more or less immediately, for instance at the time when the physician is asking his patient about his medical history. In some embodiments, virtual identification can be made when the parties can see each other's face through video link. In some embodiments, devices 502, 508, and 514 may be adapted to perform facial recognition, iris scanning, fingerprint scanning or other biometric scanning when visual identification cannot be made by the parties. In some embodiments, visual recognition or a biometric alternative is required to permit access to the EHR information to be exchanged between the parties.

In some embodiments, standardized health summaries are made available to patients for easy download from government and private healthcare portals and to be shared with their healthcare providers. Certain embodiments of the invention enable immediate and/or proximate exchange of health records and related health information between a patient and a physician, or between two physicians, in a secure fashion in real time using mobile devices 502 and 508. Certain embodiments of the invention enable secure and easy communication of EHR data from one mobile device 502 to another mobile device 508 over a local wireless network during a patient encounter with implicit or explicit patient consent. The exchange may take place in a physician's office, in an emergency room, an urgent care center, or at a hospital without a need to configure network servers and provider workstations with individual account names, addresses and security login parameters. A proximity exchange provides immediate access and secure exchange of individual health information at the time when the sender and the receiver of the information being exchanged can physically recognize each other and are reachable to each other over a network such as a wireless network.

In certain embodiments, a physician can exchange health information with a patient or with another physician using mobile devices 502, 508 and 514. The exchange can occur between two mobile phones, two tablet or other computers, or between a mobile phone and a tablet or other computer.

Patient device 502 may be adapted using an application or agent that securely stores and organizes personal health records and health information. Patient device 502 may be adapted using an application or agent that automatically accesses a patient portal account and can automatically login to retrieve current and updated patient health records. Patient device 502 may be further adapted to automatically download and combine health records from patient web portals using login and other identification and authentication maintained by the patient device 502.

In certain embodiments, patient device 502 may be adapted to capture photographs of health documents and/or body parts using a camera in the mobile device 502. Patient device 502 may be adapted using an application or agent that accesses records created by other applications on the patient's mobile device. Proximity exchange may be used to transfer one or more health records and health information to a physician.

Patient device 502 may be adapted using an application or agent that directly receives health records, such as a visit summary, a referral note, test results, patient instructions, etc., from a physician using proximity exchange from the physician's mobile device 508.

Patient device 502 may be adapted using an application or agent that enables receipt of different types of records, including documents, photographs, audio and/or video recordings that may transferred by a physician using proximity exchange from the physician's mobile device 508 and the device 502 may be further configured to store and organize records exchanged to and from different physicians.

Physician device 508 may be adapted using an application or agent that can securely store and organize individual patient records and health information associated with several patients. Physician device 508 may be adapted using an application or agent that accesses records created by other applications, such as an electronic medical record (EMR) application, on the physician's mobile device 508.

Physician device 508 may be adapted using an application or agent that takes photographs of patient records and/or patient body parts using a camera of the mobile device 508. Physician device 508 may be further adapted to create an audio recording, including follow-up care instructions, and to store such recordings as part of the patient's record on the physician's mobile device 508.

Physician device 508 may be adapted using an application or agent that directly receives health records from a patient, using proximity exchange from the patient's mobile device and that downloads health related information from a variety of provider, electronic medical record, health information exchange and other portals.

In some embodiments, either the patient or the doctor can initiate a proximity exchange. The initiator of the communication may push a button or otherwise activate a function of an agent or application of their mobile device 502 or 508. The initiator device 502 or 508 may then broadcast over the wireless network an identification that may include a name that the other party can positively identify. The recipient may be notified that a request for proximity exchange has been received and may receive the name or names of the initiator. The recipient may choose between initiators detected within range of the recipient's mobile device 502 or 508 (e.g. a different physician and a different patient may be initiating an exchange in a nearby examining room). The proximity exchange may be authorized to commence when the recipient accepts the initiator.

In one example, Bluetooth and WiFi networks may be present. A mobile device may first attempt to advertise its desire to perform a proximity exchange using a WiFi Access Point (AP) if it is able to gain access to one within its wireless range. If the devices of both communication parties are able to access the same AP at the same time then the proximity exchange is performed through the AP, otherwise an attempt is made to connect them over Bluetooth. In some embodiments, Bluetooth connections are attempted first.

In certain embodiments, data is encrypted for transfer by proximity exchange. Encryption provides security that is not dependent upon on the security features of the underlying wireless network. Patient data such as health records and personal health information may be stored in encrypted form in mobile devices 502 and 508. In one example, encryption is performed using AES encryption algorithms with a secret encryption key that may be unique for the device 502 or 508. The encryption keys may be generated during configuration and installation of the agent or application on the device 502 or 508. Encryption keys may be based on a user password and a 64 byte random number. Encryption keys may be securely stored on the device in special secured hardware. This encryption protects both the confidentiality and the integrity of the data on the mobile devices 502 and 508.

Prior to transmission by proximity exchange, encrypted data may be first decrypted using the local cryptographic key of the sending device. The decrypted data may then be encrypted using a cryptographic key, known to both sender, and receiver and that is created dynamically to exist only during the lifetime of the communication session. The Diffie-Hellman algorithm may be used to create a communication session cryptographic key in such a way that only the two mobile devices 502 and 508 know the key. When encrypted data is received at the destination device 508 or 502, it can be decrypted using the key associated with current proximity exchange and then re-encrypted using the local cryptographic key of the destination device before it is stored.

In certain embodiments, health records and related health information can be securely exchanged in real-time without the need for predefined network infrastructure. Proximity exchange may provide secure communication between two parties who can physically recognize each other and can communicate electronically with each other over a network.

In certain embodiments, personal identification and contact information can be exchanged between patient device 502 and physician device 508 as an option during proximity exchange. Personal identification information can include name, phone number, e-mail address, photograph, and such information may facilitate later contacts between the doctor and patient. In some embodiments, the contact information is exchanged automatically, without the requirement for each party to request it to be sent. Contact information may be automatically attached to records exchanged between the parties to enable easier filing and to enable accelerated retrieval on the respective devices 502 and 504.

Record owners and providers may access the record owner EHR through a personalized portal provided on a mobile device or a conventional computing platform. Record owners may access their EHR information from a plurality of different sources and may provide one or more providers with partial or complete access to their EHR information.

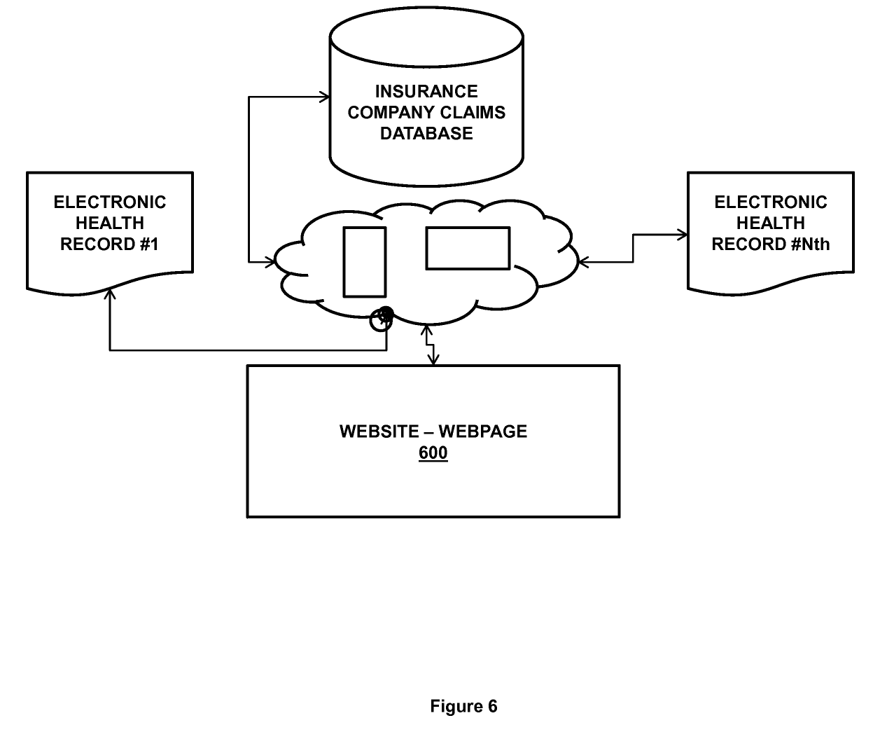

FIG. 6 illustrates a presentation of EHR information using a personalized portal according to certain aspects of the invention. The personalized portal may present a single display area that includes information from a plurality of sources including healthcare practitioners, insurance companies, an entity responsible for payment for services and other providers. EHR information may be combined remotely using a computer system or network server to access a plurality of EHR systems, before filtering and presenting the information to the record owner or provider. An aggregation server may reduce system complexity by providing identification, authentication, and qualification services related to the record owner and provider base as a centralized service, rather than requiring the plurality of EHR systems to maintain authentication information for the record owner and provider base. In some embodiments, a portal or agent may directly access and combine EHR information from the plurality of EHR systems.

Qualification services may filter results obtained from the plurality of EHR systems. Records received may be filtered based on certain predefined rules which may enforce government regulations. For example, certain records may not be accessible if access would cause healthcare information to be transferred between state or national jurisdictions. Records received may be filtered based on rules established by the record owner, a provider or the EHR system supplying the records. In one example, a record owner may determine a set of EHR records or a class of EHR records that should be withheld from one or more provider. The record owner may request that EHR records sent to a podiatrist should not include records related to psychiatric treatment, and vice versa.

An aggregator may format the information for display and/or may provide the information to an interface application that delivers a final format for display to the physician or other user. Interface application may be embodied in a portal or agent deployed on a record owner's computing device. Interface application may be provided as a plug-in on a network application at a provider location. Information provided by aggregator may be displayed in a web browser, a custom viewer application or in any suitable office automation application, such as a document reader or presentation tool. In certain embodiments, the display format may be specified and/or customized based on some combination of preferences and requirements of an end-user, a system administrator, a provider, payer and the record owner whose records are to be displayed. For example, the record owner may determine which fields are to be displayed and which data should be withheld. In another example, financial information is selected for display based on authorization levels set for the end-user.

In a certain embodiments, the record owner is a patient who receives, or expects to receive, healthcare services in a plurality of locations from multiple healthcare providers, such as his primary care provider (physician), a physician specialist and a pharmacy. The record owner may be insured by a private or public health insurance plan. Each provider may maintain separate and distinct electronic health records for the record owner. In some embodiments, record owner is permitted access to at least a portion of the records maintained by a provider on-line when such access is for the use of the record owner. For example, a record owner may access certain records from home to check on his insurance status, medical appointments, to view prescription refills, or communicate by e-mail with attending physicians.

Certain embodiments provide a record owner-controlled, practical, flexible, direct access to the record owner's health record that is continuously available. In some embodiments, the record owner may print and/or store a summary of online records on a removable storage device when it is necessary to present EHR records to one or more providers who are not users of the electronic delivery systems described herein. It will be appreciated however, that the printed or stored records are typically static and, if not updated in a timely manner, can become outdated by the time the records are presented at the point of care. Furthermore, the saved or printed record will typically not be available at all times, including during an emergency or at the time of a routine healthcare appointment, and may not be securely stored or carried; accordingly these stored or printed records can be subject to loss or tampering. Electronic access to EHR records may additionally resolve existing complex and ineffective patient consent management solutions, typically paper-based and single facility-based.

Consent may be provided by record owners as part of a request to deliver the record owner's EHR records. Certain embodiments provide direct access by healthcare providers to record owner records, whereby current record owner records are directly downloaded to the provider's system. The record owner may be required to provide authentication when requesting that a portion or all of the record owner's records are directly pushed to a provider system. In some embodiments, the record owner may also provide time-limited consent to permit a provider to request and access patient records directly from another service provider or from an aggregator. Consent may be provided directly by the record owner using a portal or agent, which may be implemented in a smart phone or other portable processing device.

A portal or agent may be provided on a computing device. A portal may provide access to a record owner's EHR information through a browser or an application or agent that resides temporarily on the computing device. The portal may comprise an application that is downloaded and executed through a browser or loaded from a portable storage device, such as a USB drive. In one example, a USB drive may be used as a credential to identify and/or authenticate a user of the USB drive, through encryption keys, biometric information, etc., and may provide an application that enables the record owner to establish a portal on the computing device. The USB drive or another credential may be issued by his insurer, the government, or his primary healthcare provider system, etc., and may maintain record owner information such as a personal and unique identifier assigned to the record owner, a record locator address and login. The USB drive may also be configured to maintain a previously downloaded EHR document, typically in encrypted form.

The portal may comprise one or more downloadable applications and may deliver services performed by a network server. An agent may be installed or otherwise maintained by a computing device. The agent typically performs one or more functions that allow a record owner to access EHR information. The agent may identify a wireless device such as an RFID, a Bluetooth-enabled device, a WiFi connected device or another device that can be used to identify the user. The agent may be an application installed on a smart phone, tablet computer or notebook computer, whereby the record owner may use an identifier to gain access to EHR information. Identification may comprise a combination of user ID, password, challenge, biometric information such as a fingerprint, iris scan, and facial scan effected by an on-board camera, and so on.

The agent or portal may be configured to perform a plurality of functions including record owner identification and authentication, access to EHR records, identification and authorization of EHR records to be pushed to a provider, aggregation of EHR records and direct push of EHR records from the record owner's personal portal to a provider's system.

In certain embodiments, a record owner may use a smart portable device that has a processor and storage. The record owner may connect a flash drive, smart card, a wirelessly connectable storage device, or the like to the computer. In one example, the record owner may present a Near Field Communication (NFC) device, such as an RFID or smart phone that responds to or activates an NFC receiver on a provider computing workstation. The record owner may also use an optical reader to capture a barcode, or biometric information that automatically enables access to the EHR information. Additionally, a device to device communication protocol between the patient's device and a provider's portable device may be employed to automatically access and exchange electronic, or initiate such exchange, with the healthcare provider.

An example of a summary form 600 is shown in FIG. 6. The summary form may be tailored to the requirements of the user, whether an EHR holder, an insurance provider, a government agency, a physician or other healthcare provider. The summary form may be formatted for ease of viewing on any suitable platform. The summary form may be presented in a single view, window and/or screen to allow a physician to access desired information in one place, with a minimum of required navigation. This single screen display can be generated on the fly and can include clinical information (e.g. in CCD/CCR format), administrative information and financial information, such as insurance eligibility information and past utilization and encounter information. The healthcare provider can typically obtain immediate access to the type, amount and location of services received by a patient, as well as out of pocket expenses incurred.

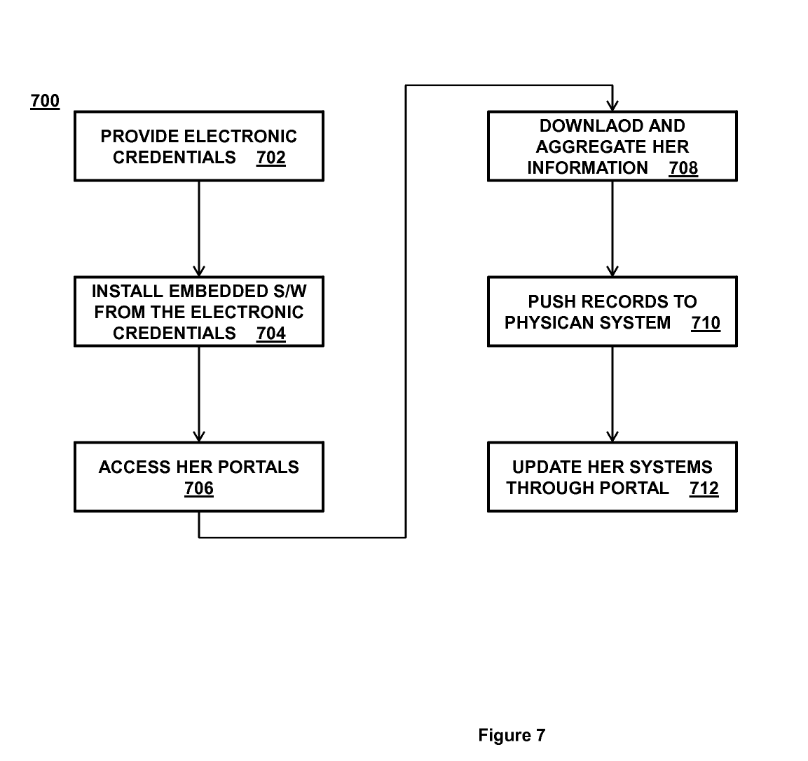

With reference to FIGS. 7 and 4, a process according to certain aspects of the invention will be described. For the purposes of the description, an example an embodiment of the invention used by military Veterans will be described, whereby a typical Veteran accesses healthcare at different Veterans Administration (VA) and non-VA provider sites and EHR information for the Veteran is maintained by government and non-government entities. In the example, an exchange can occur between points of care, whereby electronic health records can be automatically downloaded from various patient portals by a Veteran's portable computing device 414 or electronic credential 418, which has been adapted through the installation of an embedded application. Various patient portals may be accessed through device 414 or 418, including My HealtheVet at the VA, TRICARE Online, and MyMedicare.gov and other examples.

With regard to the flowchart 700 of FIG. 7, at step 702 Veteran patient may present an ID card 418 that comprises a USB flash drive. The ID card may enable automatic communication/exchange of online health records with a provider EHR system 402. At step 704, software embedded in the Veteran's card 418 is automatically loaded and executed upon insertion and/or detection by an Internet-ready computing device 416. Typically, no software or system integration is requires and the software may directly launch a login screen for entry of the Veteran's single chosen password in order to grant the provider consent of the patient to proceed.

At step 706, the device embedded software may then auto launch and automatically login into one or more of the Veteran's selected EHR enabled patient portals. The computing device 416 may then download and combine EHR records, automatically and as directed by the device embedded software. The device embedded software may additionally reformat the downloaded EHR information into a clinically prioritized format in a single view. This single view may also include a reply prompt window for the provider to send, at step 710, a follow up note, with or without attachments, to the Veteran's primary care or referring physician. The follow up note may be transmitted by secure Email, Fax and/or secure messaging.

As shown in FIG. 4, a Veteran's mobile device 414 may comprise a smart phone or tablet computer on which an application or agent has been installed or embedded, thereby obviating the need to perform steps 702 or 704. Moreover, the application or agent may adapt the Veteran's device 414 to maintain at least a summary report of EHR records. The application or agent may also be adapt the Veteran's device 414 to automatically access one or more EHR portals (step 706) and download and combine EHR records from the portals (step 708). Typically, at step 710, records can be pushed to the physician device 412 upon consent and authentication of the Veteran. The records may be pushed to a provider device 412 using, for example, a service discovery protocol. An application or agent on the provider device 412 may signal its presence, which enables the Veteran to execute a transfer of records by commanding device 414 to directly push selected records to the provider's device 412. The provider may be prompted to choose whether or not to accept the Veteran's records before or after transmission of the records by the Veteran's device 414.

The physician may optionally provide updates records to Veteran's device 412, 414 or 418 which may then be relayed to the EHR systems 402, 404, or 406 through one or more portals. Typically, the provider reviews the received records and is provided a reply prompt to send information to the Veteran's device 414. For example, the information sent by the physician may include a follow up note to the Veteran's primary care or referring physician. Optionally information such as a follow-up note may be transmitted by secure Email, Fax and/or secure messaging.

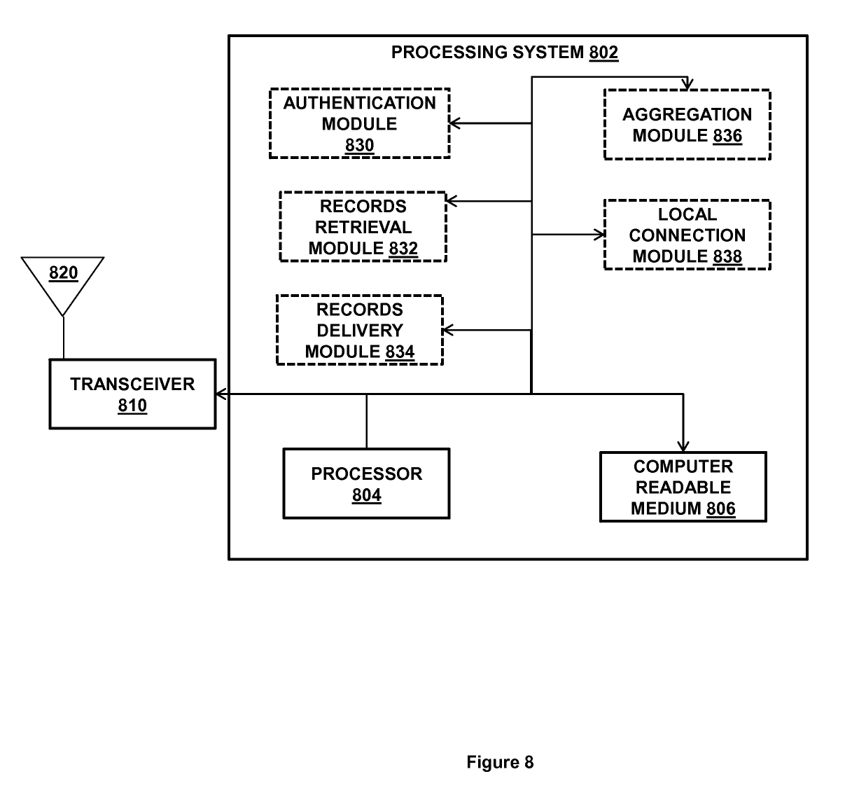

FIG. 8 is a conceptual block diagram 800 illustrating the functionality of an exemplary apparatus 802 as used in a provider location for accessing medical records. The apparatus 800 may be a portable or non-portable computing device, having a processor 804 and non-transitory storage 806 in which an agent or software may be installed that includes one or more modules 830, 832, 834, 836 and 838.

Apparatus 800 may include an authentication module 830 identifies and/or authenticates the user associated with the apparatus 800. Module 830 may identify the user using a biometric measurement, a password, user identifier, RFID device and/or a challenge.

Apparatus 800 may include a records retrieval module 832 that automatically retrieves information corresponding to the one user from at least one electronic healthcare records system using the identification to access the at least one electronic healthcare records system. Apparatus 800 may retrieve the information from the at least one electronic healthcare records system using a cellular wireless telephone network.

Apparatus 800 may include a records delivery module 834 that electronically delivers a portion of the information to a healthcare provider. The apparatus may deliver the information using transceiver 810 and antenna 820, which may be configured to support Bluetooth communications and/or communications through a wireless network, such as a WLAN or cellular network. Accordingly, apparatus 800 may comprise one or more of a wireless telephone, a smart phone and a tablet computer. A portion of the information may be delivered to a different computing device operated by the healthcare provider. A portion of the information is delivered using a server communicatively coupled to the portable computing devices associated with the one user and operated by the healthcare provider. A portion of the information may be encrypted.

Apparatus 800 may include a local connection module 838 that establishes a data and/or audio-visual link with a provider. The apparatus may establish a connection using transceiver 810 and antenna 820, which may be configured to support Bluetooth communications and/or communications through a wireless network, such as a WLAN or cellular network. Accordingly, apparatus 800 may comprise one or more of a wireless telephone, a smart phone and a tablet computer. Module 838 may perform other functions, including automatically providing consent to allow providers to download records or the user.

Apparatus 800 may include an aggregation module 836 that combines the retrieved information with other information retrieved from the at least one electronic healthcare records system to obtain combined information. The other information may comprise electronic health records of the user that are maintained by apparatus 800. Electronic health records maintained by the apparatus may be encrypted using encryption keys uniquely associated with the one user.

One or more of modules 830, 832, 834, 836 and 838 may combine to perform a method comprising the steps of receiving from a first portable computing device, information identifying a user of the first portable computing device and a request for selected healthcare records corresponding to the user and an identity of a healthcare provider, causing the first portable computing device to authenticate identity of the user, wherein the authentication of the identity of the user serves as a consent of the user to release the selected healthcare records, and upon receiving information confirming the authentication of the identity of the user, transferring the selected healthcare records to a second computing device operated by the healthcare provider. In some embodiments the portable computing device maintains encrypted information that identifies the user.

The method may further comprise updating at least a portion of the selected healthcare records using information received from the healthcare provider. The method may further comprise healthcare records other than the selected healthcare records using information received from the healthcare provider. The method may further comprise creating new healthcare records using information received from the healthcare provider.

In some embodiments, the selected healthcare records comprise records from a plurality of sources, including at least one provider source and a payer source. In some embodiments, transferring the selected healthcare records includes receiving an acceptance from the healthcare provider. In some embodiments, the user and the healthcare provider are located in close proximity and wherein the transferring the selected healthcare records is contingent on a direct visual identification made by one or more of the user and the healthcare provider. In some embodiments, the user and the healthcare provider are located in different rooms and wherein the transferring the selected healthcare records is contingent on a virtual visual identification made by one or more of the user and the healthcare provider.

In some embodiments, the network subsystem may comprise one or more Health Information Exchanges (HIEs).

The HIE may facilitate mobilization of healthcare information electronically across organizations within a region, community or hospital system. The HIE may facilitate providing the capability to electronically move clinical information among disparate healthcare information systems while maintaining the meaning of the information being exchanged. The HIE may facilitate access to and retrieval of clinical data to provide safer and more timely, efficient, effective, and equitable patient-centered care. The HIE nay be useful to public health authorities to assist in analyses of the health of the population.

The HIE may facilitate the efforts of physicians and clinicians to meet high standards of patient care through electronic participation in a patient's continuity of care with multiple providers. Secondary health care provider benefits may include reduced expenses associated with the following: 1) the manual printing, scanning and faxing of documents, including paper and ink costs, as well as the maintenance of associated office machinery; 2) the physical mailing of patient charts and records, and phone communication to verify delivery of traditional communications, referrals, and test results; and 3) the time and effort involved in recovering missing patient information, including any duplicate tests required to recover such information.

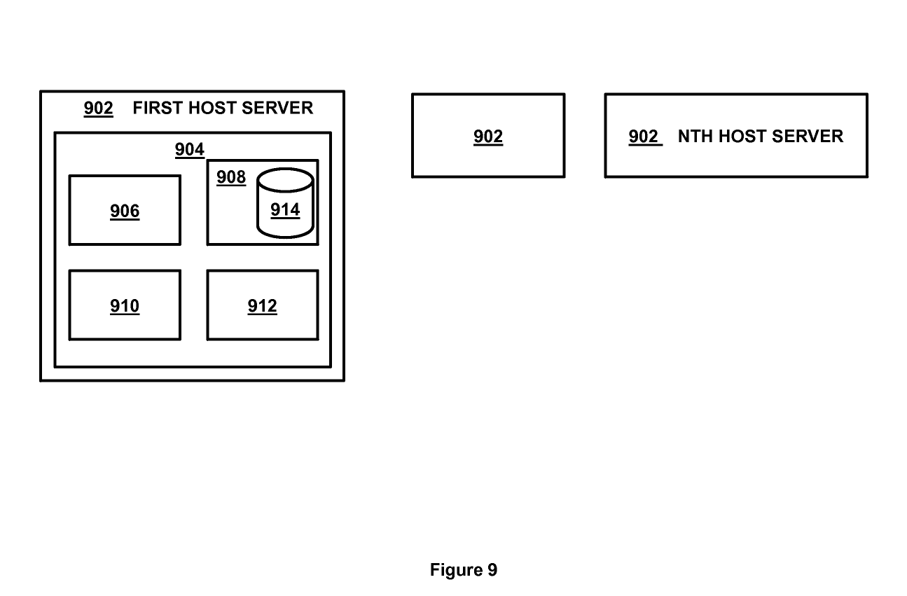

FIG. 9 depicts the network subsystem comprising the HIE, according to one or more embodiments.

In some embodiments, as depicted in FIG. 9, the HIE 900 of the network subsystem 110, of FIG. 1, may comprise one or more host servers 902, for instance one or more host computing units. The host computing units 902 may comprise a microcomputer subunit 904. The microcomputer subunit 904 may comprise a microprocessor module 906, memory module 908, an I/O module 910 and a set of support circuits 912.

The memory module 908 may comprise a database 914.

In some embodiments, the data architecture in connection with the HIE may be at least one of a federated, or decentralized, centralized and hybrid.

In some scenarios involving deployment and implementation of the centralized HIE 900, the memory module 908 may comprise the central (or master) database 914.

The central (or master) database 914 comprises a complete copy of all of the records of every patient contained in the HIE 900.

In some scenarios involving deployment and implementation of the federated HIE 900, unlike the centralized HIE 900, each healthcare provider may be responsible for maintaining the records of the individual patients owing to absence of the central (or master) database 914. The federated HIE 900 may facilitate providers in exchanging patient records among themselves as the need arises. For example, in the event that a physician in the federated HIE 900 requests the records of a given patient, a query is sent to each server in the system 100, of FIG. 1, requesting return of any and all records pertaining to the given patient. In contrast, the central (or master) database 914 in the centralized HIE 900 may comprise a previously compiled comprehensive medical record of the given patient. The previously compiled comprehensive medical record of the given patient may be stored, managed and downloaded therefrom for purposes of later use.

In short, in the federated HIE records are exchanged electronically among providers when they need them. In a centralized model all patient information is uploaded to a single database from which any provider in the HIE can download a patients full medical record.

In some embodiments, one or more host computing units of the provider subsystem may comprise a Clinical Decision Support (CDS) module.

For example, and in no way limiting the scope of the invention, the CDS module may be interactive expert system based application software.

By virtue of design, the CDS module may be capable of assisting physicians and other health professionals with decision making tasks, such as determining diagnosis of patient data. Specifically, the CDS module may be capable of linking health observations with knowledge to influence health choices by clinicians for improved health care. More specifically, the CDS module may in essence an active knowledge system thereby capable of utilizing two or more items of patient data to generate case-specific advice. Still more specifically, the CDS module may be in essence a Decision Support System (DSS) focused on using knowledge management to achieve clinical advice for patient care based on some number of items of patient data.

In operation, the CDS module may be capable of assisting clinicians at the Point of Care (POC). Specifically, in use, a clinician may interact with the CDS module thereby facilitating determination of diagnosis, analysis, etc. of patient data. An improved analysis is possible based on the combined knowledge of the clinician and the CDS module, owing to high-level of interactivity between the clinician and the CDS module, vis-à-vis individual knowledge input from at least one of the clinician and CDS module. Thus, in use, the CDS module may render recommendations as outputs or a set of outputs for the clinician to analyze. The clinician performs selection of useful information based on the process of elimination of erroneous recommendations from the CDS module.

For example, and in no way limiting the scope of the invention, in some scenarios, the CDS module may be at least one of a Knowledge-Based and non-Knowledge-Based.

Advantageously, in some embodiments involving implementation of a combined CDS and Electronic Health Record (EHR) module, one or more issues, such as medical errors, medication errors, adverse drug events and overall error reduction, may be successfully addressed.

In some embodiments, the provider subsystem may comprise a professional network service facility

The professional network service facility may be a social network service focused solely on interactions and relationships of a business nature rather than including personal, non-business interactions. For example, and in no way limiting the scope of the invention, the professional network service facility may be at least one of LINKEDIN®, VIADEO, XING, OPEN SCIENCE LAB, WISESTEP.COM, C-PROFS.COM and HALL.COM.

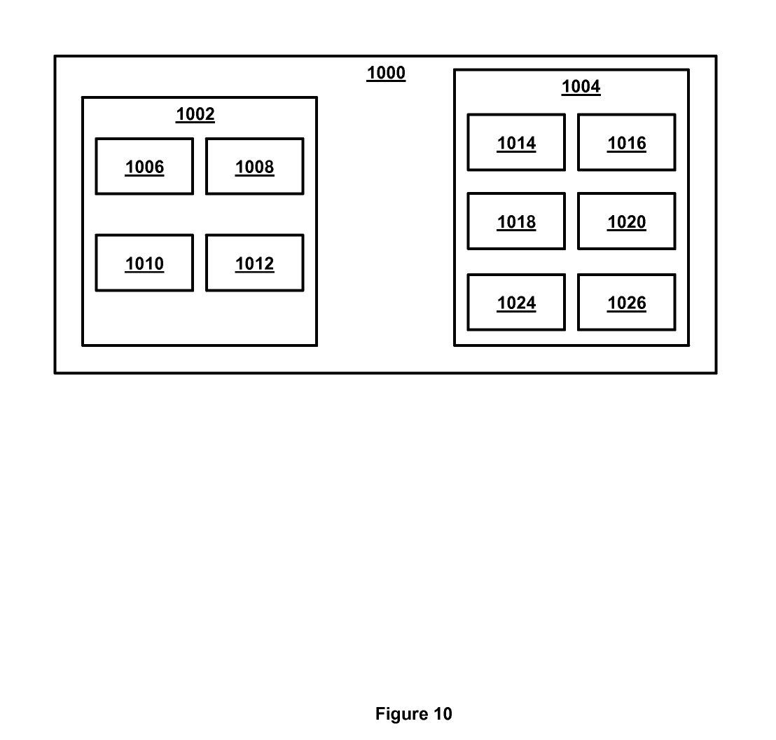

FIG. 10 depicts an integrated victim management unit deployed by the provider subsystem, according to one or more embodiments.

As depicted in FIG. 10, the integrated disaster management unit 1000 may comprise an ante-mortem subunit 1002 and a post-mortem subunit 1004. The ante-mortem subunit 1002 facilitates performance of activities carried out before an individual may be absolutely known to be deceased. For example, and in no way limiting the scope of the invention, the aforementioned activities may include recording key information about the missing individual and managing interactions with the family members of the missing individual.

The ante-mortem subunit 1002 may further comprise a call-center module 1006, missing people module 1008, family aid center module 1010 and a record management module 1012.

In some scenarios involving mass casualty events, numerous calls are generated and directed to government agencies. The call-center module 1006 may facilitate handling multiple calls from individuals reporting or enquiring about missing persons, and record basic information about both the missing persons, and the corresponding callers.

The missing people module 1008 may facilitate detective agencies or fact finders in conducting detailed interviews of family members, friends, and acquaintances of missing persons, and storing extremely detailed data ranging, for instance from clothing to physical characteristics, such as eye and hair color to tattoo or scar information.

The family aid center module 1010 may facilitate management of Family Assistance Centers (FACs), which are established to provide services to, and capture information from, the family and friends of injured, missing, or deceased disaster victims. For example, and in no way limiting the scope of the invention, the services generally provided at a FAC may include grief counseling, childcare, religious support, facilitation of family needs, such as hotel, food, and transportation, ante-mortem data collection by the investigative authorities and the medical examiner, and notification of death to the next of kin. In addition, the family aid center module 1010 may facilitate tracking all interactions and appointments with the family of missing persons, and managing the personal items of victims received from family members for identification purposes.

The record management module 1012 may facilitate handling requests for records from family members, lawyers, and public administrators, thereby providing “Chain of Custody” for all records.

The post-mortem subunit 1004 may further comprise a field operations module 1014, disaster mortuary management module 1016, disaster victim identification module 1018, dental identification module 1020, pandemic influenza module 1024 and an administrative module 1026.

The field operations module 1014 may facilitate users in managing incidents, field investigation, and the collection of remains and evidence, as well as maintaining records and documentation about remains and evidence. In some scenarios involving unavailability of Internet connectivity at disaster sites, the field operations module 1014 may comprise a MICROSOFT WINDOWS-based client capable of capturing and storing data off-line and synchronizing with the main database upon availability of Internet connectivity.

The disaster mortuary management module 1016 may facilitate mortuary management functionality. The disaster mortuary management module 1016 may facilitate access of remains, both check-in and check-out, examination of remains by medical examiner and anthropologist, tracking and documentation of autopsies and individual remains and the final disposition of remains to funeral homes.

The disaster victim identification module 1018 may facilitate bidirectional (from ante- to post-mortem and back) one-to-many search capabilities based on multiple criteria. The disaster victim identification module 1018 may possess considerable identification tracking capabilities including DNA, fingerprint, radiology, and dental. The disaster victim identification module 1018 may enable identification review and verification, including DNA re-sampling. The disaster victim identification module 1018 may also enable the consolidation of fragmented remains as they are uncovered.

The disaster victim identification module 1018 may facilitate performance of notification tracking, including communication both with family members and media about a given decedent. The disaster victim identification module 1018 may be capable of issuing death certification upon at least one of failure and success in detection of remains. The disaster victim identification module 1018 also facilitates maintaining a log of all family communications, and scheduling and tracking family visits.

The dental identification module 1020 may be in essence a forensic odontology add-on. The dental identification module 1020 may possess detailed charting, complex and advanced search, and the ability to look for anomalies.

The administrative module 1026 may facilitate users creating incidents, to which missing persons are associated, conducting records management and carrying out other system administration tasks.

In some embodiments, for example, and in no way limiting the scope of the invention, the integrated victim management unit 1000 UVIS may be a multi-tiered, browser- and WINDOWS-based application, based MICROSOFT technology, and running on a minimum configuration of MICROSOFT WINDOWS SERVER 2003 and MICROSOFT SQL 2000/2005 as the database engine.

In some embodiments, the system may facilitate identity and attribute management, in accordance with the principles of the present invention. Specifically, the system may facilitate establishing a common credentialing platform thereby allowing centralized management of electronic identities and attributes of the credential holders, creating benefits of scale and reducing redundant processes. For example, state and local governments may leverage the credentialing process as part of the current suitability and on-boarding processes of the state and local governments. The credentials may be used for both day-to-day activities, such as physical access to facilities and logical access to computers and networks, in addition to emergency response. The aforementioned multi-use approach facilitates building Return on Investment (ROI) by reducing organizational spending on multiple identity management infrastructure solutions. The common credentialing platform may serve as central source for identity thereby facilitating a single infrastructure to be leveraged across organizations and applications.

An object of the present invention is to provide a healthcare database for individual patients.

Another object of the present invention is to provide a healthcare database for individual patients that is controlled by individual patients.

Yet another object of the present invention is to provide a healthcare database for individual patients which compiles and maintains a complete personal medical history of an individual patient and provides easy access thereto.

Still another object of the present invention is to provide a database of healthcare information accessible by the Internet.

The foregoing objects are basically attained by a method of creating and maintaining a consumer-driven healthcare database, comprising the steps of providing a first set of medical data from a first healthcare provider to a data management system, with the first set of medical data containing medical information regarding a healthcare consumer. The method also includes the steps of providing a second set of medical data from the healthcare consumer to the data management system, with the second set of medical data containing medical information regarding the healthcare consumer, and the healthcare consumer has access to the first and second sets of medical data. In addition, the method includes categorizing each of the first and second sets of medical data, respectively, within the data management system into at least a first category, and retrieving selected portions of data by the healthcare consumer from either of the first and second sets of medical data, respectively. Also, the method includes supplying the selected portions of data to either one of the healthcare consumer and a second healthcare provider.

By creating and maintaining a data management system in this manner, the individual patient can control and disseminate their own medical information as well as access medical data provided by one or more healthcare institutions regarding the patient.

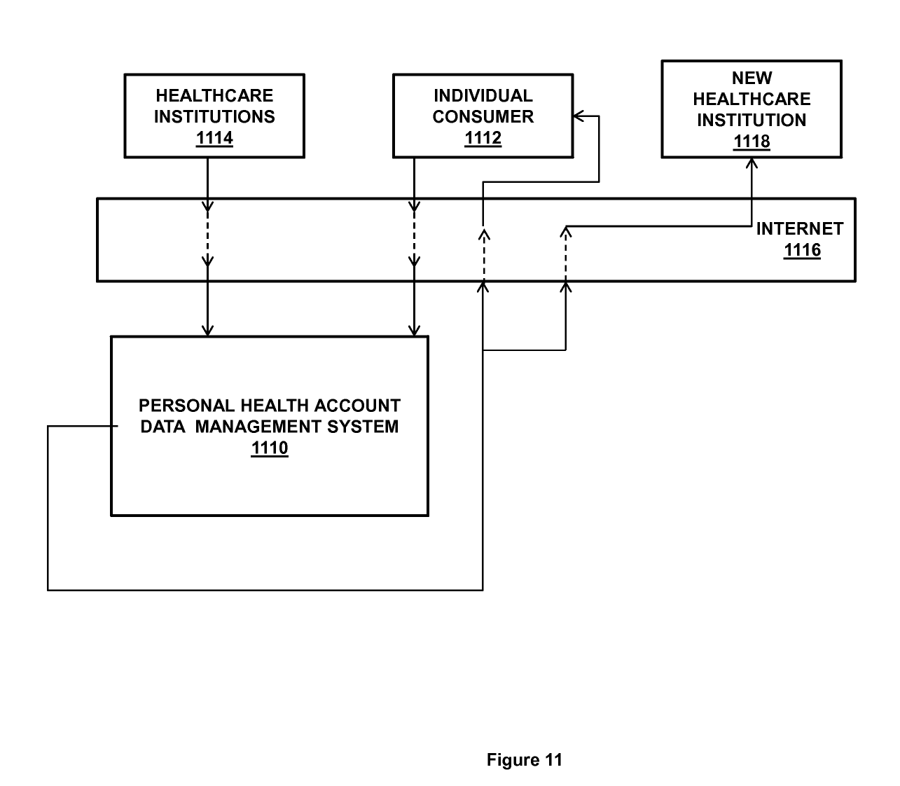

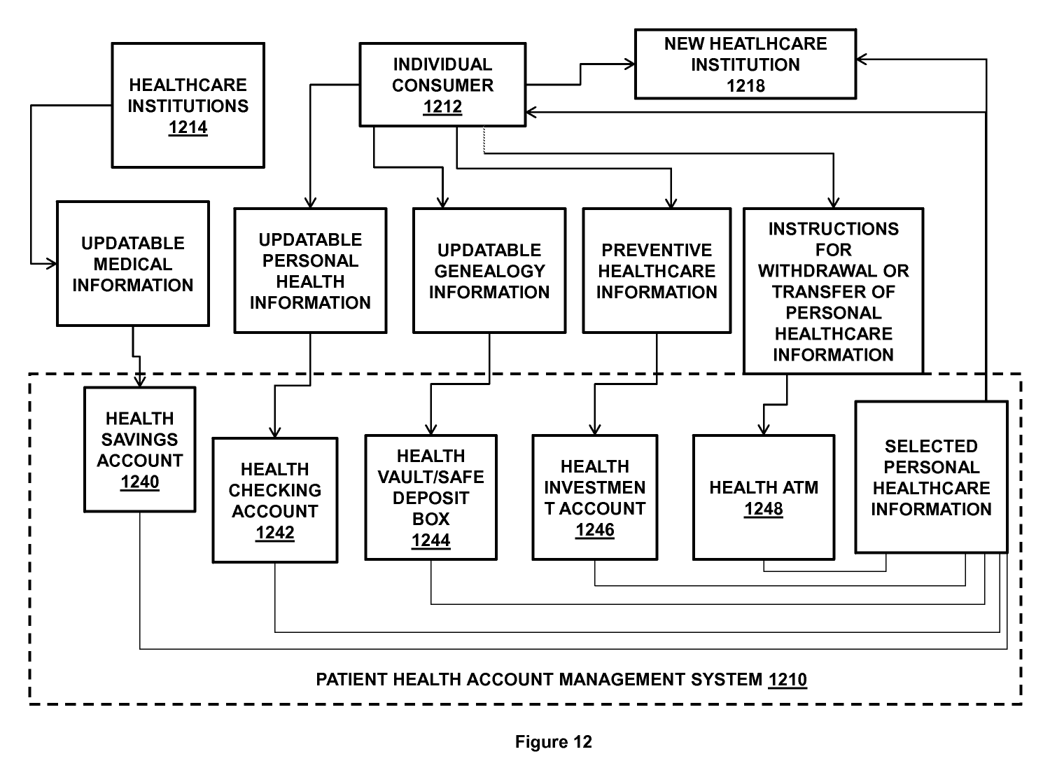

Referring to FIGS. 11-12, the present invention allows consumers of healthcare to conduct and control the movement of their healthcare records virtually and globally. It also permits the consumer to electronically transfer their personal health records from one institutional data system to another by mapping individual protocols of one system to another.

An example of a preferred embodiment of the present invention includes a data management system 1110 that can receive information from an individual consumer or patient 1112 of the healthcare system and from healthcare institutions 1114, such as hospitals, doctor offices, laboratories, and so on, as seen in FIG. 11. Also, the management system 1110 can be easily accessed by the consumer 1112 in order to perform a variety of functions, including obtaining the healthcare data stored by the management system 1110 or forwarding the data to another healthcare institution 1118 which requires the information.

The data management system 1110 preferably includes a computer database capable of being remotely accessed. The remote access to the system 1110 preferably occurs through the Internet 1116, World Wide Web, or similar system, but can take any acceptable form, such as through telephone communications. Additionally, the connections with the data management system 1110 can be through telecommunication lines or through wireless technology, such as through the use of satellite technology.

The data management system 1210 includes multiple, interconnected and updateable computer databases, including a health savings account 740, a health checking account 1242, a health vault/safe deposit box 1244, and a health investment account 1246, as seen in FIG. 12. The data management system 1210 also includes a data-managing device in the form of a Health ATM 1248. The ATM 1248 acts as an automated teller machine to enable the consumer 1212 to manage the data stored within the system 1210. For example, the consumer 1212 can access the information within the data management system 1210 and perform functions such as move, transfer or withdraw the information.

The invention allows the consumers 1212 to manage their healthcare information and movement by providing multiple categories of control by the consumers 1212. In one category, the consumer 1212 makes a deposit of personal health information into the checking account 1242, which can be constantly updated by the consumer 1212 and stored by the management system 1210. The personal health information can include any relevant health information, such as, cholesterol levels, weight, blood type, and so on.

In a second category, information that is critical to the genealogy of the consumer's family and the health history of the consumer's family, such as heart conditions, diabetes, and so on, can be inserted and stored in the electronic vault 1244. Thus, the data management system 1210 includes the accumulation of both the institutional data and the personal data to form a complete medical record of the consumer 1212.

In a third category, health information from various sources such as healthcare institutions 1214, such as hospitals, doctors' offices, laboratories, and various medical departments, such as a radiology or oncology department, will be permanently transferred to the health savings account 1240 for consumer 1212 control and long-term storage. The permanent health information can include any relevant health information, such as surgeries, hospitalizations, doctor visits and diagnoses.

A fourth category of control allows the consumer 1212 to store and access medical information regarding preventative care with the investment account 1246. For example, in healthcare information can be provided to the consumer 1212, to educate the consumer 1212 on healthcare matters. For example, “push technologies” can be employed to send health reminders, health information relevant to the individual or family member, the latest chronic disease management advice, or information on first aid. Also, health risk assessments and scheduling reminders for preventative care examinations can be included within account 1246.

In a fifth category of control, the consumer 1212 can selectively retrieve the medical data from either of the savings account 1240, the checking account 1242, the health vault 1244, and the investment account 1246 to transfer the data to other parties as needed. If consumer health information is needed by a new healthcare entity 1218, such as a new doctor, the consumer 1212 can select, via the ATM 1248, to electronically or otherwise transfer specific data or the entire medical record to new healthcare entity 1218 or institution. This allows only the consumer 1212 to transfer their medical data.

Also, the consumer 1212 can withdraw or retrieve healthcare information from any of the savings account 1240, the checking account 1242, the health vault 1244, and the investment account 1246 as needed. For instance, the consumer 1212 can upload some or all of their personal healthcare information to a personal digital assistant, such as a Palm Pilot, or to a personal computer, and formulate a hard copy if desired.

As stated above, the consumer 1212 can access the data management system 1210 in any number of ways, including the consumer 1212 connecting to the Internet and logging onto the web site of the management system 1210. The information can be transmitted to the management system 1210 in any number of ways, including using computers and transferring the data to the management system 1210 via the Internet.

It should be understood that the invention preferably includes the ability for any data transmitted and received between any of the consumer 1212, the institutions 1214 and 1218, and the management system 1210, to be encrypted prior to being transmitted in an unsecured manner, such as via the Internet, and then deciphered once received by the intended entity.

The embodiment of the subject invention described above further enables individual consumers 1212 to manage their personal health records in the same way as their personal bank account using “pull technology.” The management system 1210 provides its e-health consumers 1212 the capability of depositing their medical information (e.g., cholesterol levels, weight, blood type, etc.) into the health checking account 1242. Permanent information such as surgeries and hospitalizations will be stored in their health savings account 1240. Personal family history such as heart conditions and diabetes will be kept secured in a ‘virtual vault’ 1244, creating a legacy health record that can be passed onto future generations as part of a family's genealogical archive.

Consumers 1212 will be able to withdraw, via the ATM 1248, key health information and transfer it to a new physician or healthcare provider via smart cards, paper, or other electronic mediums when needed, such as when embarking on a cruise or other travels, where it would otherwise not be accessible. Further, the ATM 1248 can be used to view information globally via the Internet or by other computer-based systems, such as on a personal digital assistant, such as a Palm Pilot.

In summary, the invention permits a single, central, store and retrieval location for all of the consumer's health information. Accordingly, a consumer 1212 does not have to search through different providers' offices, ask relatives, and so on. to find required medical information. Additionally, through the use of the ATM 1248, with either card or cardless access, consumers 1212 can access their health information immediately and in emergencies, while being assured that the information is secure and confidential during storage as well as any transmission of data. Finally, by accessing the management system 1210, for instance, via the Internet, the consumer 1212 can be directed and linked to other relevant healthcare web sites.

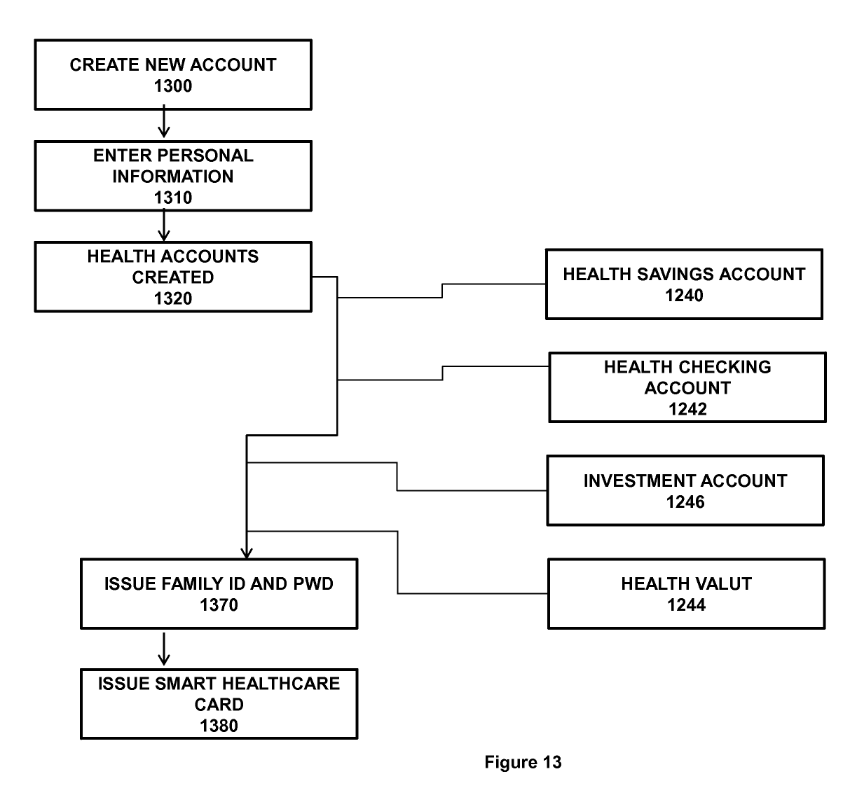

FIG. 13 illustrates a flowchart showing an example of a preferred manner for creating a new account for the consumer 1212 in the management system 1210. Specifically, once the account creation process is begun in step 1300, personal information is loaded into a computer program adapted to receive the specific information in step 1310. The health accounts are thus created in step 1320, and information is distributed within the system 1210 to the appropriate accounts 1240, 1242, 1246 or the vault 1244, in steps 1330, 1340, 1350 and 1360, until transfer, withdrawal or other manipulation at a later date. Then, the consumer 1212 is issued an identification card and password in step 1370 to maintain confidentiality, as well as an ATM card with identifying information in step 1380 to allow access to the accounts in any variety of ways, when necessary.

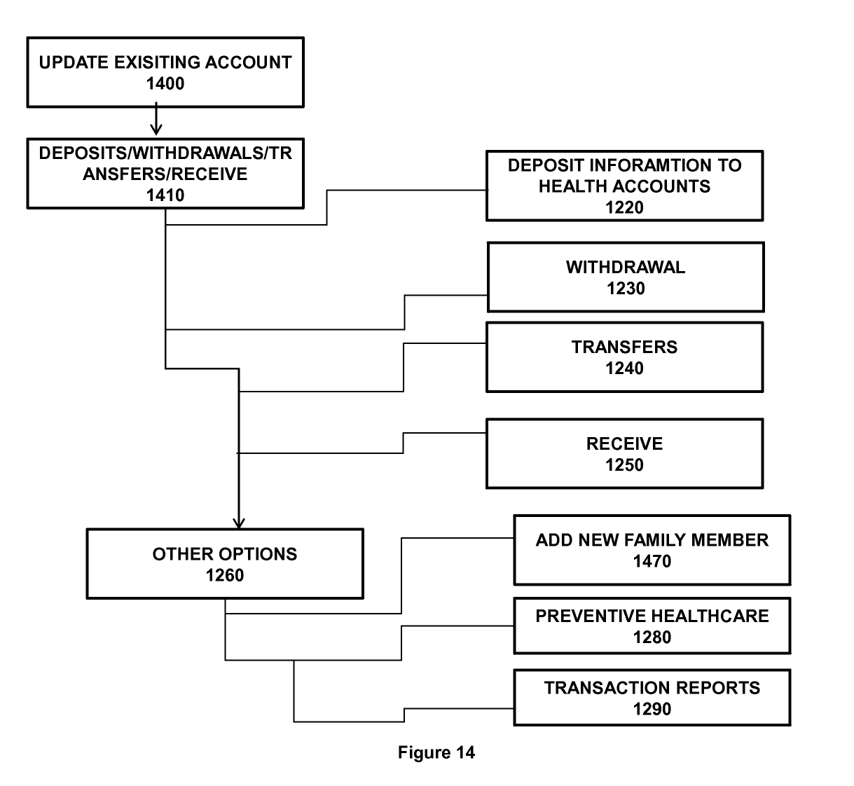

FIG. 14 illustrates a flowchart showing an example of a preferred manner for updating an existing account for the consumer 1212 in the management system 1210. Specifically, once the updating process is begun in step 1400, the information in the account is updated in step 1410 with new information by a deposit, or is withdrawn or transferred in the system 1210. The information is then distributed within the system 1210 to the appropriate accounts 1240, 1242, 1246 or the vault 1244, in steps 1420 through 1450, until transfer, withdrawal or other manipulation at a later date. Beginning at step 1460, the consumer 1212 also is presented with additional options to add additional family member (step 1470), receive health reminders from the investment account 1246 (step 1480) or receive transactional reports such as health account summaries or recent transaction information (step 1490). Also, health savings account 1240 can receive updated medical information from healthcare institutions 1214.

Generally described, one embodiment of the invention provides a subsystem for insuring a party, comprising a database containing, for an insurance product, predetermined coverage(s), predetermined limits, and a fixed premium amount, and containing, for one or more categories of insured, characteristics of members of the category; a user computing device configured to provide to a carrier automated system information relating to an applicant and a request for a determination whether the applicant is a member of one or more of the categories of insured in the database eligible for the insurance product; wherein the carrier automated system is configured to receive the information and the request from the user computing device, to compare the information provided relating to the applicant with category characteristics from the database for determining whether the applicant is a member of one or more of the categories of insured in the database eligible for the insurance product, and to provide a response to the user computing device based on the determination of eligibility, and if the applicant is eligible, the response providing an offer to bind the applicant to the insurance product; and a network allowing the user computing device to access the carrier automated system and allowing the carrier automated system to access the database.

The characteristics of members of a category in the database may, in one embodiment, not include a risk level to be met by an applicant individually. The coverages may include liability coverage.

The carrier automated system may be further configured in an embodiment of the invention to communicate over the network with one or more third party information sources to seek verification of information provided relating to the applicant. The carrier automated system may seek the verification of information at a time selected from prior to providing an offer to bind the applicant to insurance or subsequent to providing an offer to bind the applicant to insurance.

In an embodiment of the invention, the network comprises the Internet, and the carrier automated system comprises a carrier server operating a website.

In an embodiment of the invention, the user computing device may be associated with an agent representing the applicant. Alternatively, the user computing device may be associated with the applicant.

In an embodiment of the invention, the coverages comprise business owners insurance, and the characteristics of a member category include (separately or in combination): business classification, sales volume, number of employees, payroll amount, credit score, or premises size.

According to another embodiment, the invention provides a method for insuring a party, comprising providing a database containing, for an insurance product, predetermined coverages, predetermined limits, and a fixed premium amount, and containing, for one or more categories of insureds, characteristics of members of the category; sending from a user computing device to a carrier automated system over a network information relating to an applicant and a request for a determination whether the applicant is a member of one or more of the categories of insureds in the database eligible for the insurance product; receiving at the carrier automated system the information and the request from the user computing device; comparing at the carrier automated system the information provided relating to the applicant with category characteristics from the database to determine whether the applicant is a member of one or more of the categories of insureds in the database eligible for the insurance product; and providing a response from the carrier automated system to the user computing device based on the determination of eligibility, and if the applicant is eligible, the response including an offer to bind the applicant to the insurance product.

According to another embodiment, the invention provides a storage device having stored thereon instructions executable by a computer for providing a fixed price for predetermined coverages and coverage limits associated with a category of insureds; screening information received relating to a customer to determine whether the customer has predetermined characteristics making the customer eligible for the policy, the predetermined characteristics not including a risk level; and issuing insurance for the predetermined coverages and coverage limits at the fixed price if the customer is eligible.

According to another embodiment, the invention provides a subsystem for insuring a party, comprising: a database containing, for an insurance product, predetermined coverages, predetermined limits, and a fixed premium amount, and containing, for one or more categories of insureds, characteristics of members of the category; a carrier automated system having access to the database and being configured to receive information relating to an applicant and a request for a determination whether the applicant is a member of one or more of the categories of insureds in the database eligible for the insurance product, to compare the information provided relating to the applicant with category characteristics from the database for determining whether the applicant is a member of one or more of the categories of insureds in the database eligible for the insurance product, and if the applicant is eligible, providing an offer to bind the applicant to the insurance product.

According to another embodiment, the invention provides a subsystem for providing a business owner's insurance policy, comprising: a database containing acceptable profile values for characteristics of micro business insurance customers, a fixed price, and predetermined coverages and coverage limits for a business owner's insurance policy; and one or more computer systems having access to the database and being configured to execute computer software: to calculate acceptable profile values for characteristics of micro business insurance customers based on data for existing customers in similar micro businesses, and set the fixed price and predetermined coverages and coverage limits for the business owner's insurance policy based on the data, at least two of the characteristics selected from the group consisting of micro business classification, payroll amount, credit score, premises size, sales volume, and number of employees; to store the acceptable profile values, fixed price and predetermined coverages and coverage limits for the business owner's insurance policy in the database; to receive application information for a micro business party describing aspects of the micro business party's business related to the selected characteristics; to compare the application information received for the micro business party to the acceptable profile values; and in response to the application information for the micro business party having acceptable values for the characteristics, to offer the micro business party the business owner's insurance policy having the predetermined coverages and coverage limits at the fixed price without further risk analysis of the micro business party.

According to another embodiment, the invention provides a method for providing a business owner's insurance policy, comprising: calculating acceptable profile values for characteristics of micro business insurance customers based on data for existing customers in similar micro businesses, and setting a fixed price and predetermined coverages and coverage limits for a business owner's insurance policy based on the data, at least two of the characteristics selected from the group consisting of micro business classification, payroll amount, credit score, premises size, sales volume, and number of employees; receiving application information for a micro business party describing aspects of the micro business party's business related to the selected characteristics; comparing the application information received for the micro business party to the acceptable profile values; and in response to the application information for the micro business party having acceptable values for the characteristics, offering the micro business party the business owner's insurance policy having the predetermined coverages and coverage limits at the fixed price without further risk analysis of the micro business party.

According to another embodiment, the invention provides a method for providing a business owner's insurance policy, comprising: calculating acceptable profile values for characteristics of micro business insurance customers based on data for existing customers in similar micro businesses, and setting a fixed price and predetermined coverages and coverage limits for a business owner's insurance policy based on the data, at least two of the characteristics selected from the group consisting of micro business classification, payroll amount, credit score, premises size, sales volume, and number of employees; receiving application information for a micro business party describing aspects of the micro business party's business related to the selected characteristics; comparing the application information received for the micro business party to the acceptable profile values; in response to the micro business party having acceptable values for the characteristics, verifying the truth of the application information; and in response to successful verification of the application information, offering the micro business party the business owner's insurance policy having the predetermined coverages and coverage limits at the fixed price without further risk analysis of the micro business party.

From the customer's point of view, the invention eliminates unknown factors (for example by providing an up front price rather than making the customer walk through an application process to reach the price), provides a well-defined product that is easy to understand, and provides a more efficient process.

The system of the present invention comprises a computer based subsystem for rapid triage of patients in a hospital emergency department setting so that each patient is consistently and comprehensively evaluated upon entering the emergency department, regardless of the level of training of the personnel involved in the initial evaluation of the patient and regardless of the patient's problem. The system is to be employed by emergency department medical professionals to provide a standardized method for evaluating and prioritizing patients based on the criticality of their conditions, thus providing a more reliable and better prioritization of patient care in the emergency department setting.

This subsystem includes overlapping pathways for evaluating and assigning a triage level to a patient's condition based on the medical professional's observations about the patient's condition, the patient's age, the patient's vital signs, and a series of scripted questions and observations in a selected algorithm that is selected based on the patient's chief complaint. The subsystem is designed to prevent hospital personnel from not recognizing the criticality of certain life threatening conditions and the resulting postponement of treatment based on an initial error in identifying the severity of the patient's problem. The subsystem also allows the medical profession flexibility in the order in which the steps of triage are done and entered into the system, including the ability to postpone completion of triage on one patient so that triage can be begun on one or more other patients.

The subsystem has special triage routines for children who face the greatest danger of misevaluation in triage due to their limited ability to communicate and due to the differences in their physiology as compared to adult patients.

The triage subsystem includes a computer interface so that the emergency department physician has constant real time information on the criticality of each patient in the emergency department, thereby enabling the medical personnel to provide priority attention to those patients that have the most critical conditions. The computer interface of the triage subsystem also provides the treating physician with a print out of the patient's information at the time the physician first sees the patient. That print out is a permanent record of the triage process for that patient.

In some embodiments, the system of the present invention comprises a web based integrated informatics subsystem for healthcare services. In one embodiment, this is accomplished by one or more client device, one or more server including at least one control logic module, one or more databases for maintaining a plurality of health care related information for users and one or more communication network integrating the server, the client device and the database to communicate with each other, wherein the system is configured to receive information or request sent by one or more client devices, where the received information/s or request/s are processed by the control logic of the server, where the control logic processes the information or request based on the business and data logics with the all available databases, the processed request is integrated with relevant healthcare information or services and received by the client device.

In some embodiments, the system comprises a web based integrated informatics subsystem for healthcare services is disclosed, in accordance with the principles of the present invention. The web based integrated informatics subsystem comprises at least one client device including at least one interactive user interface module to provide access to the system, wherein the interactive user interface module allows the user to interact with the system by way of providing or searching health related information or services as per user's requirements, at least one server including at least one control logic module, wherein the control logic module assists and/or suggests a health care services based on the user's requirement, a plurality of databases for maintaining a plurality of health care related information for users, wherein the users including one or more health care experts, and a communication network integrating the server, the client device and the database to communicate with each other, wherein the subsystem is configured to receive information or request sent by one or more client devices, where the received information/s or request/s are processed by the control logic of the server, where the control logic processes the information or request based on the business and data logics with the all available databases, the processed request is integrated with relevant healthcare information or services and received by the client device.

### Example Computer System

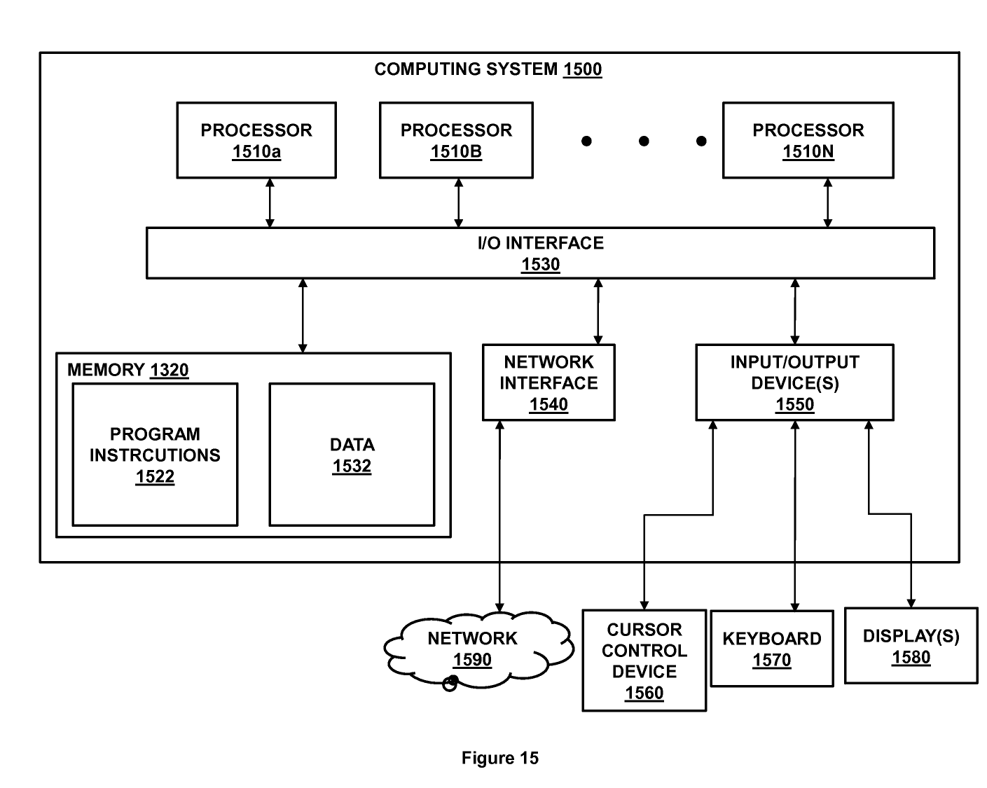

FIG. 15 depicts a computer system that is at least one of a portable computing and communications device and a computer and can be utilized in various embodiments of the present invention, according to one or more embodiments.

Various embodiments of method and apparatus for managing spam, as described herein, may be executed on one or more computer systems, which may interact with various other devices. One such computer system is computer system 1500 illustrated by FIG. 15, which may in various embodiments implement any of the elements or functionality illustrated in FIGS. 1-14. In various embodiments, computer system 1500 may be configured to implement one or more methods described above. The computer system 1500 may be used to implement any other system, device, element, functionality or method of the above-described embodiments. In the illustrated embodiments, computer system 1500 may be configured to implement one or more methods as processor-executable executable program instructions 1522 (e.g., program instructions executable by processor(s) 1510A-N) in various embodiments.

In the illustrated embodiment, computer system 1500 includes one or more processors 1510A-N coupled to a system memory 1520 via an input/output (I/O) interface 1530. The computer system 1500 further includes a network interface 1540 coupled to I/O interface 1530, and one or more input/output devices 1550, such as cursor control device 1560, keyboard 1570, and display(s) 1580. In various embodiments, any of components may be utilized by the system to receive user input described above. In various embodiments, a user interface (e.g., user interface) may be generated and displayed on display 1580. In some cases, it is contemplated that embodiments may be implemented using a single instance of computer system 1500, while in other embodiments multiple such systems, or multiple nodes making up computer system 1500, may be configured to host different portions or instances of various embodiments. For example, in one embodiment some elements may be implemented via one or more nodes of computer system 1500 that are distinct from those nodes implementing other elements. In another example, multiple nodes may implement computer system 1500 in a distributed manner.

In different embodiments, computer system 1500 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 1500 may be a uniprocessor system including one processor 1510, or a multiprocessor system including several processors 1510 (e.g., two, four, eight, or another suitable number). Processors 1510A-N may be any suitable processor capable of executing instructions. For example, in various embodiments processors 1510 may be general-purpose or embedded processors implementing any of a variety of instruction set architectures (ISAs), such as the x96, POWERPC®, SPARC®, or MIPS® ISAs, or any other suitable ISA. In multiprocessor systems, each of processors 1510A-N may commonly, but not necessarily, implement the same ISA.

System memory 1520 may be configured to store program instructions 1522 and/or data 1532 accessible by processor 1510. In various embodiments, system memory 1520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 1520. In other embodiments, program instructions and/or data may be received, sent or stored upon different types of computer-accessible media or on similar media separate from system memory 1520 or computer system 1500.

In one embodiment, I/O interface 1530 may be configured to coordinate I/O traffic between processor 1510, system memory 1520, and any peripheral devices in the device, including network interface 1540 or other peripheral interfaces, such as input/output devices 1550. In some embodiments, I/O interface 1530 may perform any necessary protocol, timing or other data transformations to convert data signals from one components (e.g., system memory 1520) into a format suitable for use by another component (e.g., processor 1510). In some embodiments, I/O interface 1530 may include support for devices attached through various types of peripheral buses, such as a variant of the Peripheral Component Interconnect (PCI) bus standard or the Universal Serial Bus (USB) standard, for example. In some embodiments, the function of I/O interface 1530 may be split into two or more separate components, such as a north bridge and a south bridge, for example. Also, in some embodiments some or all of the functionality of I/O interface 1530, such as an interface to system memory 1520, may be incorporated directly into processor 1510.

Network interface 1540 may be configured to allow data to be exchanged between computer system 1500 and other devices attached to a network (e.g., network 1590), such as one or more external systems or between nodes of computer system 1500. In various embodiments, network 1590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1540 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1550 may, in some embodiments, include one or more display terminals, keyboards, keypads, touchpads, scanning devices, voice or optical recognition devices, or any other devices suitable for entering or accessing data by one or more computer systems 1500. Multiple input/output devices 1550 may be present in computer system 1500 or may be distributed on various nodes of computer system 1500. In some embodiments, similar input/output devices may be separate from computer system 1500 and may interact with one or more nodes of computer system 1500 through a wired or wireless connection, such as over network interface 1540.

In some embodiments, the illustrated computer system may implement any of the methods described above, such as the methods illustrated by the flowcharts of FIGS. 5, 11 and 12. In other embodiments, different elements and data may be included.

Those skilled in the art will appreciate that computer system 1500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 1500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1500 may be transmitted to computer system 1500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. An improved method for smart healthcare management, the method comprising:
querying a card database via a card DBMS of a smart healthcare card comprising overall patient information of a patient using a smart healthcare card reader;
adaptively and dynamically determining one or more contextual attributes of the overall patient information via identification, analysis and selection of one or more usable attributes based on the query;
allowing selective access and retrieval of the one or more contextual attributes of the overall patient information by the smart healthcare card reader;
analyzing the selectively accessed and retrieved contextual attributes using a host computing unit coupled to the smart healthcare card reader;
recommending at least one of healthcare products, solutions, services and therapeutic regimens using the host computing unit coupled to the smart healthcare card reader; and
tracking efficacy of the at least one of recommended healthcare products, solutions, services and therapeutic regimens using the host computing unit coupled to the smart healthcare card reader.

2. The method of claim 1, wherein the smart healthcare card reader is coupled to a health ATM.

3. The method of claim 1, wherein the overall patient information of the smart healthcare card comprises a regular and a distress Personal Identification Number (PIN).

4. The method of claim 3, wherein the distress PIN is used for at least one of A) Authentication, Authorization and Accounting (AAA) of the patient owing the smart healthcare card and B) availing emergency healthcare facilities provided by one or more healthcare service providers in at least one of unknown, unexpected, unwanted and untimely situations.

5. The method of claim 1, wherein the step of analyzing the selectively accessed and retrieved optimal attributes using a host computing unit coupled to the smart healthcare card reader comprises:
capturing one or more physiological attributes of the patient using one or more physiological sensors using a portable computing and communications device,
capturing responses of the patient to one or more subjective and objective questionnaire, and
consolidating the captured physiological attributes, responses to the subjective and objective questionnaire and the selectively accessed and retrieved contextual attributes of the patient.
